(19) United States
(12) Patent Application Publication
(10) Pub. No.: US 2024/0141217 A1
(43) Pub. Date: May 2, 2024

(54) RESIN SHEET AND USE THEREOF

(71) Applicant: NITTO DENKO CORPORATION, Ibaraki-shi, Osaka (JP)

(72) Inventors: Satoshi HONDA, Ibaraki-shi, Osaka (JP); Masahiro KUZE, Ibaraki-shi, Osaka (JP); Kenichi OKADA, Ibaraki-shi, Osaka (JP); Takayuki KUROKAWA, Sapporo-shi, Hokkaido (JP); Jian Ping GONG, Sapporo-shi, Hokkaido (JP)

(21) Appl. No.: 18/280,161

(22) PCT Filed: Feb. 28, 2022
(86) PCT No.: PCT/JP2022/008223

§ 371 Date: Sep. 1, 2023

(30) Foreign Application Priority Data
Mar. 3, 2021 (JP) 2021-033311

(51) Int. Cl. C09J 167/00; C08J 5/18; C09J 7/38; C09J 133/08

(52) U.S. Cl. CPC C09J 167/00; C08J 5/18; C09J 7/38; C09J 133/08

(57) ABSTRACT

Provided is a resin film that has a stress integral value of greater than 10 MPa and 1000 MPa or less when uniaxially stretched at a tensile speed of 300 mm/min at 25° C. until it breaks. The resin film showing these properties is supple and durable.

### TECHNICAL FIELD

The present invention relates to a resin sheet, a pressure-sensitive adhesive sheet comprising the resin sheet, a resin composition for forming the resin sheet, and a method for producing a resin sheet.

This application claims priority to Japanese Patent Application No. 2021-033311 filed on Mar. 3, 2021; and the entire content thereof is herein incorporated by reference.

### BACKGROUND ART

In general, pressure-sensitive adhesive (PSA) exists as a soft solid (a viscoelastic material) in a room temperature range and has a property to adhere easily to an adherend with some pressure applied. For such a property, PSA has been widely used in various fields in the form of a PSA sheet comprising a PSA layer. Technical documents related to PSAs include Patent Documents 1 to 17.

### CITATION LIST

### Patent Literature

[Patent Document 1] PCT International Publication No. WO 2018/055859
[Patent Document 2] Japanese Patent No. 5858468
[Patent Document 3] Japanese Patent No. 5696345
[Patent Document 4] Japanese Patent No. 5696994
[Patent Document 5] Japanese Patent No. 5850585
[Patent Document 6] Japanese Patent No. 6070674
[Patent Document 7] Japanese Patent No. 5505766
[Patent Document 8] Japanese Patent No. 6325777
[Patent Document 9] Japanese Patent No. 6325778
[Patent Document 10] Japanese Patent No. 6694744
[Patent Document 11] Japanese Patent No. 5004633
[Patent Document 12] Japanese Patent No. 6581694
[Patent Document 13] Japanese Patent No. 6338915
[Patent Document 14] PCT International Publication No. 2019/131888
[Patent Document 15] Japanese Patent Application Publication No. 2017-115149
[Patent Document 16] Japanese Patent Application Publication No. 2018-193537
[Patent Document 17] Japanese Patent Application Publication No. 2008-191309

### SUMMARY OF INVENTION

### Technical Problem

In a typical example of PSA structures, a base polymer that shows rubber elasticity in a room temperature range is included and that base polymer is suitably crosslinked to form a network. With respect to PSA sheets for semiconductor processing, Patent Document 1 proposes a PSA layer in which a so-called double network is formed with interlaced first and second networks. It is said that such a PSA layer is likely to have good breaking properties and is less susceptible to leftover adhesive residues when removed from a work such as a semiconductor wafer (paragraph [0019], etc.).

It is known that when a PSA is peeled from the adherend, stringiness is observed, in which part of the PSA is greatly deformed and stretched with formation of threads at the peel interface. Here, if the PSA threads have weak resistance to stretching, they generally have low peel strength on the adherend. If the PSA threads are torn off in the middle, the tom-off PSA remains on the adherend, leaving adhesive residues. Increasing the crosslink density of the PSA to increase the breaking stress (stress at break) can be an effective means of preventing leftover adhesive residue. However, in general, with increasing crosslink density of a PSA, the deformability (flexibility) of the PSA tends to decrease. Insufficient deformability of the PSA gives rise to an impediment to thread formation at the peel interface. Even if threads are formed, they will be separated from the adherend before greatly stretched. As such, the tightness of adhesion to the adherend and peel strength are likely to decrease.

Thus, it will be useful to provide a resin film that can be used as a PSA sheet or its constituent (typically a PSA layer) and that stretches well, yet requires a suitable amount of force to stretch, that is, a supple and durable resin film. However, the PSA layer specifically disclosed in Patent Document 1 does not satisfy the target level for the present inventors in terms of suppleness and durability. The PSA layers specifically disclosed in Patent Documents 2 to 17 are not flexible or durable enough at the target level for the present inventors, either.

The present invention has been made in view of such circumstances with an objective to provide a supple and durable resin sheet and a PSA sheet comprising the resin sheet. Another related objective is to provide a resin composition for forming the resin sheet. Yet another related objective is to provide a method for producing a supple and durable resin sheet.

### Solution to Problem

This description provides a resin film that has a stress integral value of greater than 10 MPa and 1000 MPa or less when uniaxially stretched at a tensile speed of 300 mm/min at 25° C. until it breaks (fractures). Such a resin film is supple and durable; and therefore, it can be preferably used, for instance, as a PSA sheet or its constituent.

The resin film according to some embodiments has an elongation at break of 300% or higher and 4500% or lower when uniaxially stretched at a tensile speed of 300 mm/min at 25° C. until it breaks.

The resin film having an elongation at break in this range is preferable in view of combining flexibility (e.g., flexibility suited as a PSA sheet or its constituent) with suppleness and durability in a well-balanced manner.

The resin film according to some embodiments has a hysteresis of 1.2 or higher and 20 or lower, obtained by the test described later. The resin film with a degree of hysteresis within this range can suitably exhibit suppleness and durability.

The resin film according to some embodiments shows necking behavior that results in a ratio (Wₘᵢₙ/Wₘₐₓ) of higher than 0 and 0.90 or lower based on the undermentioned necking test. In this way, with a resin film in which necking is observed during stretching, suppleness and durability are more likely to be obtained as compared with a resin film in which necking is not observed during stretching.

The resin film according to some embodiments comprises first and second networks coexisting in the same layer, and the first and second networks are physically interlaced with each other. Such a structure can preferably bring about a supple and durable resin film.

In some embodiments, the first network is a cured product of a first material and the first material comprises a polymer (a1) having reactive functional groups (f1). The second network is a cured product of a second material and the second material comprises a polyfunctional monomer (b1) having two or more reactive functional groups (f2) in one molecule. Such a structure can preferably bring about a supple and durable resin film.

In some embodiments, an acrylic polymer can be preferably used as the polymer (a1). The acrylic polymer preferably has a weight average molecular weight (Mw) of 80×10⁴ or higher. The resin film whose first network is formed from an acrylic polymer with such Mw is suited for making a supple and durable resin film because the first network can stretch well while being less susceptible to tearing.

In the embodiment in which the polymer (a1) is an acrylic polymer, based on the average number (A) of functional groups of all the monomers in the second material, the number (B) of parts (by weight) of all the monomers used per 100 parts by weight of the polymer (a1), the average molecular weight C of all the monomers, and the weight average molecular weight D of the polymer (a1), the composition index Y1 is preferably 0.20 or higher and 0.85 or lower, determined by the following equation (1):

Y1=[(AB/C)/D]×10⁷ (1)

When the composition index Y1 is in the above range, a supple and durable resin film can be preferably obtained. The composition index Y1 can be, for instance, 0.21 or higher, 0.25 or higher, 0.30 or higher, 0.35 or higher, or even 0.40 or higher. The composition index Y1 can be, for instance, 0.75 or lower, 0.70 or lower, 0.65 or lower, or even 0.60 or lower.

The resin film disclosed herein can also be preferably made in an embodiment in which the polymer (a1) is a polyester-based polymer. In such an embodiment, based on the average number (A) of functional groups of all the monomers in the second material, the number (B) of parts (by weight) of all the monomers used per 100 parts by weight of the polymer (a1), the weight average molecular weight C of all the monomers, and the number average molecular weight D′ of the polymer (a1), the composition index Y2 is preferably 6.0 or higher and 7.0 or lower, determined by the following equation (2):

Y2=[(AB/C)/D′]×10⁷ (2)

When the composition index Y2 is in the above range, a supple and durable resin film can be preferably obtained.

This description provides a PSA sheet comprising a resin film disclosed herein. For instance, the PSA sheet may be a PSA sheet with or without substrate, the PSA sheet including the resin film as a PSA layer; or a sheet with substrate, including the resin film as the substrate.

This description provides a resin composition used for forming a resin film disclosed herein. For instance, the resin composition may comprise a first material that comprises a polymer (a1) having reactive functional groups (f1) as well as a second material that comprises a polyfunctional monomer (b1) whose molecule has two or more reactive functional groups (f2) different from the reactive functional groups (f1). The resin composition may further comprise, as necessary, a crosslinking agent that mainly reacts with either the reactive functional groups (f1) or (f2), and a photoinitiator to accelerate photocuring of either the reactive functional groups (f1) or (f2). By curing such a resin composition, it is possible to form a structure in which the first network (the cured product of the first material) and the second network (the cured product of the second material) are physically interlaced with each other, preferably bringing about a resin film having a stress integral value of greater than 10 MPa and 1000 MPa or less.

The scope of the invention for which the present patent application seeks patent protection includes a suitable combination of the respective features described above.

As evident from the breaking stress and breaking elongation shown in Table 1, the PSA layers specifically disclosed in Patent Document 1 all have stress integral values far below 10 MPa. Patent Documents 2 to 7 disclose PSAs having interpenetrating polymer network structures. However, the PSA layers specifically disclosed in these Patent Documents have one, two or more inappropriate selections among the weight average molecular weight of the polymer forming the network structure, the number of functional groups and functional group equivalents of the polyfunctional monomer, the quantitative balance, etc.; and therefore, none of them satisfy the requirement of stress integral value greater than 10 MPa. The PSA layers according to the specific examples described in Patent Documents 8 to 17 do not satisfy the stress integral exceeding 10 MPa, either.

### BRIEF DESCRIPTION OF DRAWINGS

FIG. 1 shows a cross-sectional diagram schematically illustrating an embodiment of the PSA sheet comprising a resin film.

FIG. 2 shows a cross-sectional diagram schematically illustrating another embodiment of the PSA sheet comprising a resin film.

FIG. 3 shows a cross-sectional diagram schematically illustrating another embodiment of the PSA sheet comprising a resin film.

### DESCRIPTION OF EMBODIMENTS

Preferred embodiments of the present invention are described below. Matters necessary to practice this invention other than those specifically referred to in this description can be understood by a person skilled in the art based on the disclosure about implementing the invention in this description and common general knowledge at the time of application. The present invention can be practiced based on the contents disclosed in this description and common technical knowledge in the subject field. In the drawings referenced below, a common reference numeral may be assigned to members or sites producing the same effects, and duplicated descriptions are sometimes omitted or simplified. The embodiments described in the drawings are schematized for clear illustration of the present invention, and do not necessarily represent the accurate size or reduction scale of an actual product provided.

The resin film disclosed by this description can be adhesive, non-adhesive, or low-adhesive. Here, the adhesive resin film refers to a resin film having a peel strength of 0.1 N/20 mm or greater, determined based on JIS Z0237(2009) on a SUS304 stainless steel plate as the adherend in an environment at 23° C. by press-bonding the resin film to the adherend with a 2 kg roller moved back and forth once, and after 30 minutes, peeling the resin film in the 180° direction at a tensile speed of 300 mm/min. Such an adhesive resin film can be thought as a PSA layer or as a PSA sheet formed of the PSA layer (i.e., a PSA sheet without substrate). The non-adhesive or low-adhesive resin film refers to a resin film whose peel strength is less than 0.1 N/20 mm. Typical examples of the concept of non-adhesive or low-adhesive resin film here include a resin film that when press-bonded to a SUS304 stainless steel plate with a 2 kg roller moved back and forth once in an environment at 23° C., will not stick to the stainless steel plate (a resin film substantially lacking adhesiveness).

### <Properties of Resin Film>

### (Stress Integral Value)

This description provides a resin film having a stress integral value of greater than 10 MPa and 1000 MPa or less. The stress integral value corresponds to the integrated stress applied while the sample is uniaxially stretched up to the elongation at break. Good stretchiness and strong stretch resistance combined in a well-balanced manner favorably brings about a stress integral value of greater than 10 MPa, leading to supple and durable properties. The resin film having such properties can be preferably used as a PSA sheet that comprises the resin film as a PSA layer, for instance. The PSA layer having a high stress integral value can form supple and durable threads in the thread formation that occurs during removal from the adherend. This can advantageously contribute to combining high peel strength with good anti-adhesive transfer properties, increasing impact resistance, etc. In a PSA sheet, the resin film can be used as a component (e.g., a substrate film, an adhesive or non-adhesive inner layer, etc.) other than the PSA layer that constitutes an adhesive face (contact surface with the adherend) to provide the PSA sheet with supple and durable properties.

The stress integral value is determined by a tensile test in which a measurement sample is uniaxially stretched at 25° C. at a tensile speed of 300 mm/min until it breaks. The measurement sample used is prepared from the resin film of interest, as a cylinder with a diameter of about 0.5 mm to 3 mm (preferably about 0.5 mm to 2 mm, e.g., about 1 mm) or as a rod with an equivalent cross-sectional area. At 25° C., using a tensile tester, the sample is pulled until it breaks at a chuck distance (distance between chucks) of 10 mm at a tensile speed of 300 mm/min. During this, the stress values are obtained at given elongations (%) of the sample. The stress integral value is determined based on the resulting stress (MPa) vs. elongation (%) curve and the stress values at the respective elongations. For instance, stress values are obtained every 2.5% elongation from the initial length (10 mm) of the sample; and these stress values are totaled to determine the stress integral value according to the total value (MPa)×2.5(%)/100. As the tensile testing machine, EZ-S 500N available from Shimadzu Corporation or a comparable system can be used. More specifically, the stress integral value is determined by the method described later in Examples.

With respect to the shape of the measurement sample, at least the 10 mm segment placed between the chucks has mostly constant cross-sectional area and shape. The sample can be prepared by suitably combining operations on the resin film such as cutting, winding (e.g., rolling up in one direction), laminating, folding, etc. In doing so, it is desirable to pay attention not to apply a load in the direction in which the sample is stretched. As necessary, the operations of rolling, laminating, folding, etc., may be carried out under moderately heated conditions (e.g., at a temperature of about 30° C. to 80° C.) to help mold the sample into a rod shape. In this case, the prepared sample is used for the tensile test after sufficient equilibration to the temperature of the measurement environment.

The tensile test is desirably carried out using a measurement sample consisting of the resin film of interest alone. On the other hand, when the resin film of interest has another layer laminated thereon that is difficult to separate therefrom and it is reasonably expected that the stress required for stretching the other layer is clearly smaller than the stress required for stretching the resin film (e.g., when the resin film is used as the substrate film in a PSA sheet with substrate), for convenience, it is possible to use the stress integral value obtained by carrying out the tensile test using a measurement sample prepared from the laminated sheet formed of the resin film and the other layer, as an alternative value for the stress integral value obtained by using a measurement sample consisting of the resin film of interest alone. Here, when conducting the tensile test using a measurement sample prepared from the laminated sheet formed of the resin film and the other layer (i.e., a measurement sample formed of the resin film of interest and the other layer), the stress value obtained at each given elongation (%) of the sample is determined per cross-sectional area of the resin film of interest. The same applies to the measurements of hysteresis, elongation at break, strength at break, and ratio of stress integration area described later. It is noted that among the specific examples shown in this description, in Example 8, the respective property values were determined by performing tensile tests using measurement samples prepared from the laminated sheet of the resin film of interest (the resin film of Example 8) and another layer (the PSA layer of Example 9).

The stress integral value is preferably 11 MPa or greater, more preferably 13 MPa or greater, possibly 15 MPa or greater, 18 MPa or greater, 20 MPa or greater, or even 22 MPa or greater. With increasing stress integral value, a more supple and durable resin film can be obtained. In some embodiments, the stress integral value can be, for instance, 30 MPa or greater, 45 MPa or greater, 60 MPa or greater, 100 MPa or greater, 200 MPa or greater, 300 MPa or greater, or even 400 MPa or greater. From the standpoint of obtaining flexibility suited as a PSA sheet or its constituent, the stress integral value is suitably 1000 MPa or less, preferably 800 MPa or less, or more preferably 600 MPa or less. In some embodiments, the stress integral value can be 500 MPa or less, 300 MPa or less, 100 MPa or less, 50 MPa or less, or even 30 MPa or less.

The stress integral value can be adjusted by selecting the resin film structure, constituent materials, etc. For instance, in an undermentioned double network structure in which the first and second networks are interlaced, the stress integral value can be adjusted by suitably setting one, two or more parameters among the following: the species, molecular weight, crosslinking method and crosslink density of the polymer used for forming the first network; the species, molecular weight and number of functional groups of the monomer(s) used for forming the second network; the weight ratio of the first and second networks; and the like. In some embodiments, by setting these parameters in view of the composition indices Y1 and Y2 described later, it is possible to obtain a resin film that shows a preferable stress integral value disclosed herein.

The resin film disclosed by this description includes an embodiment in which the stress integral value is not limited. In such an embodiment, the resin film is not limited to those having these properties.

### (Hysteresis)

The copresence of the first and second networks in the same layer of the resin film can favorably bring about such a stress integral value. The first and second networks preferably form a double network structure in which they are physically interlaced with each other through net holes. The second network preferably has a finer mesh than the first network. When stretching a resin film having such a structure, as a general tendency, when the strain reaches a certain point, the second network starts to break (fracture); as the strain increases, the fracture develops, followed by breaking of the first network. The resin film having a double network structure can exhibit supple and durable properties because the second network thus serves as a so-called sacrificial network against stretching.

In a resin film having a double network structure with the second network serving as a sacrificial network, when the resin film is subjected to stretching (first stretching cycle) to a length where the second network develops a fracture to some extent followed by a temporary relaxation of the stretching stress and then again to stretching (second stretching cycle), with the second network already having a partial fracture, the second stretching cycle shows a different stress-strain curve up to the length of the first stretching cycle, proceeding at lower stress. This kind of property is called hysteresis. This can confirm the formation of a double network structure. The resin film with a level of hysteresis in a suitable range may favorably exhibit supple and durable properties.

The level of hysteresis can be evaluated by the method described later, using a measurement sample prepared in the same manner as the abovementioned evaluation of the stress integral value. For instance, in the evaluation of the stress integral value, if the breaking elongation is 1000% (X %) determined by stretching a sample A, a cycle test is carried out as follows: A measurement sample (sample B for hysteresis measurement) prepared in the same manner as the sample A above is first uniaxially stretched to 700% (0.7X) (first stretching cycle) and held for 1 second at the end of stretching; then pulled back to the chuck distance of 10 mm and held for 10 seconds; then uniaxially stretched to 800% (second stretching cycle) and held for 1 second at the end of stretching; and then pulled back to the chuck distance of 10 mm. In the first cycle of stretching, a stress S1 is required to stretch it to 660% (0.7X (%)−40%) elongation. In the second cycle of stretching, a stress S2 is required to stretch it to the same length (i.e., 660% elongation). From S1 and S2, S1/S2 is determined and this value is used as the hysteresis.

In some embodiments of the resin film disclosed herein, the hysteresis is, for instance, possibly 1.2 or higher, suitably above 1.2, preferably 1.3 or higher, more preferably 1.5 or higher, potentially 1.6 or higher, or even 1.7 or higher. From the standpoint of readily obtaining a supple and durable resin film that shows a greater breaking elongation, in some embodiments, the hysteresis is preferably 1.9 or higher, more preferably 2.0 or higher, possibly 2.2 or higher, 2.4 or higher, or even 2.6 or higher. The maximum hysteresis is not particularly limited. In some embodiments, for practical point of view such as maintaining suitable elasticity even in the second and subsequent cycles of stretching, the hysteresis is suitably 20 or lower, preferably 15 or lower, more preferably 10 or lower, possibly 8.0 or lower, 6.0 or lower, 4.0 or lower, or even 3.0 or lower.

The hysteresis can be adjusted by selecting the resin film structure, constituent materials, etc. For instance, the stress integral value can be adjusted by suitably setting one, two or more parameters among the following: the species, molecular weight, crosslinking method and crosslink density of the polymer used for forming the first network; the species, molecular weight and number of functional groups of the monomer(s) used for forming the second network; the weight ratio of the first and second networks; and the like. In some embodiments, by setting these parameters in view of the composition indices Y1 and Y2 described later, it is possible to obtain a resin film that shows a suitable hysteresis.

### (Elongation at Break)

The elongation at break (breaking elongation) of the resin film disclosed herein is not particularly limited. For instance, it can be about 100% to 5000% (preferably about 250% to 4000%). For combining flexibility suited as a PSA sheet or its constituent with supple and durable properties in a well-balanced manner, in some embodiments, the breaking elongation is preferably 300% or higher, more preferably 450% or higher, possibly 600% or higher, 750% or higher, 900% or higher, or even 1000% or higher. In some embodiments, the resin film has a breaking elongation of suitably 4500% or lower, preferably 3000% or lower, possibly 2400% or lower, 2200% or lower, 1700% or lower, or even 1500% or lower. For instance, in the case of a resin film used as a PSA layer that constitutes an adhesive face, it is preferable not to have an excessive breaking elongation from the standpoint of suppressing leftover adhesive residue on the adherend.

The breaking elongation is obtained by recording the elongation when the sample breaks in the analysis of the stress integral value described above. The breaking elongation can be adjusted by selecting the resin film structure, constituent materials, etc.

### (Stress at Break)

The stress at break (breaking stress) of the resin film disclosed herein is not particularly limited. From the standpoint of readily obtaining a supple and durable resin film (e.g., a resin film having a stress integral value of greater than 10 MPa), in some embodiments, the resin film may have a breaking stress of, for instance, about 0.5 MPa to 100 MPa. The preferable range of breaking stress may vary depending on the material and application of the resin film. For instance, with respect to the resin film comprising an acrylic polymer as the polymer (a1) described later, the breaking stress is preferably about 2 MPa to 50 MPa. Among such, for the resin film used as a PSA layer, it is more preferably about 2 MPa to 10 MPa (e.g., 2 MPa to 6 MPa); and for the resin film used as a substrate film, it is more preferably about 5 MPa to 50 MPa (e.g., 5 MPa to 25 MPa). With respect to the resin film comprising a polyester-based polymer as the undermentioned polymer (a1), the breaking stress is preferably about 10 MPa to 100 MPa.

The breaking stress is determined by recording the elongation when the sample breaks in the analysis of the stress integral value described above. The breaking stress can be adjusted by selecting the resin film structure, constituent materials, etc.

### (Ratio of Stress Integration Area)

The resin film disclosed herein has a ratio of stress integration area suitably above 30% (i.e., above 0.3), advantageously above 35%, preferably above 40%, or more preferably above 45%. The ratio of stress integration area is determined from the stress integral value (MPa), breaking stress (MPa) and breaking elongation (%) obtained by the abovementioned methods, according to the next equation:

(Stress integral value×100)/(breaking stress×breaking elongation)

When a sample is tensile-stretched, the ratio of stress integration area increases with increasing stretched length measured after the stress value is increased to a certain level through the fracture of the sample. Thus, it can be said that a resin film with a higher stress integration area ratio is more supple and durable. A particularly preferable resin film satisfies at least a prescribed stress integral value and at least a prescribed elongation at break while having at least a prescribed stress integration area ratio. In some embodiments, the stress integration area ratio can be 50% or higher or above 50%, 55% or higher or above 55%, or even 60% or higher or above 60%. From the standpoint of obtaining flexibility suited as a PSA sheet or its constituent, the maximum stress integration area ratio is suitably 95% or lower, preferably 90% or lower, possibly 85% or lower, or even 80% or lower.

A resin film with a high stress integration area ratio can be preferably realized as a resin film having a double network structure in which the first and second networks are physically interlaced with each other through net holes. It is thought that as the resin film having a double network structure is stretched, the second network starts to break when the stress value reaches a certain level with increasing strain; however, in the presence of the first network interpenetrating with the second network, a rapid fracture of the second network leading to premature breakage is avoided, and the fracture of the second network develops gradually while the high stress value is maintained at a relatively high level; and this tends to increase the ratio of stress integration area.

### (Necking)

The resin film according to some preferable embodiments shows a behavior such that when its sample is uniaxially stretched, the sample undergoes non-uniform lengthwise narrowing. Hereinafter, such a behavior is referred to as necking. For instance, in a preferable resin film, necking is observed when a measurement sample prepared in the same manner as in the evaluation of the stress integral value is uniaxially stretched under the conditions described in the working examples described later. For instance, a resin film having the double network structure may preferably exhibit such a property. Presumably, this is because when a resin film having a suitable double network structure is stretched, even if the second network starts to break at one point (location) in the sample, the first network interlaced with the second network undergoes the sort of deformation to disperse the stress and avoid premature breakage of the sample at this location; and as a result, before this location suffers a fracture, the second network starts to break at one, two or more other points of the sample. Thus, it can be said that a resin film where necking is observed tends to have a higher stress integral value than a resin film where necking is not observed when stretched (i.e., its sample undergoes uniform lengthwise narrowing), and is supple and durable.

In particular, the presence or absence of necking can be determined by the following necking test.

### [Necking Test]

(1) Samples A and C are obtained for breaking elongation measurement and necking measurement, respectively.
(2) At 25° C., the sample A is uniaxially stretched at a tensile speed of 300 mm/min until it breaks to determine the elongation at break, X (%).
(3) At 25° C., the sample C is uniaxially stretched at a tensile speed of 300 mm/min from the initial chuck distance to 0.5X (%). At the end of stretching, within 1 second after the end of stretching, a photograph of the stretched sample is taken with a digital camera. The photograph is taken from a direction perpendicular to the stretching direction of the sample.
(4) With respect to the middle 60% range excluding 20% from each end (i.e., the chuck side) of the stretched sample, the sample's minimum width Wₘᵢₙ and maximum width Wₘₐₓ are measured in number of pixels. It is judged as follows: when their ratio (Wₘᵢₙ/Wₘₐₓ) is higher than 0 and 0.90 or lower, necking is present; when higher than 0.90, necking is absent.

For superior necking behavior, in some embodiments, the ratio (Wₘᵢₙ/Wₘₐₓ) is preferably 0.85 or lower, more preferably 0.80 or lower, possibly 0.75 or lower, or even 0.70 or lower. The minimum ratio (Wₘᵢₙ/Wₘₐₓ) can be, for instance, 0.01 or higher. For superior supple and durable properties, it is preferably 0.05 or higher, more preferably 0.10 or higher, possibly 0.20 or higher, 0.30 or higher, or even 0.40 or higher.

Described in detail below are resin film compositions capable of realizing the abovementioned properties with a reference to a resin film having a structure with the first and second networks coexisting in the same layer and physically interlaced with each other through net holes. The resin film disclosed herein is not limited to these compositions and species having such structures.

### <First Network>

(Polymer (a1))

The first network is preferably a cured product of a first material. For instance, by crosslinking a first material comprising a polymer (a1), the first material can be cured to form the first network. The species of polymer (a1) is not particularly limited. Among polymers that can be used as PSA sheet forming materials, a species suited for obtaining a supple and durable resin film can be suitably selected. Examples of possible material choices for the polymer (a1) include, but are not limited to, an acrylic polymer, rubber-based polymer, polyester-based polymer, urethane-based polymer, polyether-based polymer, silicone-based polymer, polyolefin, and polyvinyl chloride. Favorable examples of the polymer (a1) include acrylic polymers and polyester-based polymers.

The polymer (a1) has a weight average molecular weight (Mw) of, for instance, possibly 1×10⁴ to 500×10⁴, or preferably 2×10⁴ to 300×10⁴. The polymer (a1) preferably has a Mw that is not too low in view of inhibiting premature fracture of the first network during stretching of the resin film. When the polymer (a1) has a Mw that is not too high, it becomes easier to form a double network structure in which the first and second networks are suitably interlaced.

It is noted that unless otherwise noted, the weight average molecular weight (Mw) and the number average molecular weight (Mn) of the polymer (a1) refer to values based on standard polystyrene, obtained by gel permeation chromatography (GPC). As the GPC system, for instance, model name HLC-8320GPC (column: TSKgel GMH-H(S), available from Tosoh Corporation) can be used. If the manufacturer or the like provides a nominal value, that value can be used.

To facilitate curing of the first material, the polymer (a1) preferably has reactive functional groups (f1). Examples of the reactive functional groups (f1) include, but are not limited to, a carboxy group, acid anhydride group, hydroxy group, sulfonate group, phosphate group, amino group, amide group, epoxy group, cyano group, isocyanate group, alkoxysilyl group, ethylenically unsaturated group (e.g., acryloyl group, methacryloyl group, vinyl group, allyl group, etc.), and benzophenone structure. In the polymer (a1), the reactive functional group (f1) can be present in a side chain, at a terminal, or at both locations.

### (Acrylic Polymer)

In some preferable embodiments, the polymer (a1) is an acrylic polymer. As used herein, the term “acrylic polymer” refers to a polymer derived from a starting monomer mixture including more than 50% acrylic monomer by weight (preferably more than 70% by weight, e.g., more than 90% by weight). The acrylic monomer refers to a monomer having at least one (meth)acryloyl group per molecule. As used herein, the term “(meth)acryloyl” comprehensively refers to acryloyl and methacryloyl. Similarly, the term “(meth)acrylate” comprehensively refers to acrylate and methacrylate, and the term “(meth)acryl” comprehensively refers to acryl and methacryl.

The acrylic polymer as the polymer (a1) is preferably a polymer of a starting monomer mixture that comprises an alkyl (meth)acrylate as the primary monomer and may further comprise a secondary monomer copolymerizable with the primary monomer. The primary monomer here refers to a component accounting for more than 50% by weight in the starting monomer mixture. As the alkyl (meth)acrylate, it is preferable to use an alkyl (meth)acrylate having a linear or branched alkyl group with 1 up to 20 carbon atoms at the ester terminus. Hereinafter, an alkyl (meth)acrylate having, at the ester terminus, an alkyl group with X number up to Y number of carbon atoms may be referred to as an “C_{X-Y} alkyl (meth)acrylate.”

Non-limiting specific examples of the C₁₋₂₀ alkyl (meth)acrylate include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, stearyl (meth)acrylate, isostearyl (meth)acrylate, nonadecyl (meth)acrylate, and eicosyl (meth)acrylate.

In some embodiments, for easy balancing of properties, the ratio of C₁₋₂₀ alkyl (meth)acrylate in the starting monomer mixture used for preparing the acrylic polymer is suitably higher than 40% by weight, for instance, possibly 45% by weight or higher, 50% by weight or higher, 55% by weight or higher, or even 60% by weight or higher. The ratio of C₁₋₂₀ alkyl (meth)acrylate in the starting monomer mixture can be 100% by weight. However, for easy balancing of properties, it is typically suitably 98% by weight or lower, for instance, possibly 95% by weight or lower, or even 90% by weight or lower. In some embodiments, from the standpoint of enhancing the PSA layer's cohesion, the ratio of C₁₋₂₀ alkyl (meth)acrylate in the starting monomer mixture can be, for instance, 85% by weight or lower, 80% by weight or lower, 75% by weight or lower, 70% by weight or lower, 65% by weight or lower, or even 60% by weight or lower.

In some embodiments where the resin film disclosed herein is expected for use as a PSA layer, as the alkyl (meth)acrylate, it is preferable to use at least a C₄₋₂₀ alkyl (meth)acrylate and it is more preferable to use at least a C₄₋₁₈ alkyl (meth)acrylate. Particularly preferable C₄₋₂₀ alkyl (meth)acrylates include n-butyl acrylate (BA) and 2-ethylhexyl acrylate (2EHA). Other specific examples of C₄₋₂₀ alkyl (meth)acrylates that can be preferably used include isononyl acrylate, n-butyl methacrylate (BMA), 2-ethylhexyl methacrylate (2EHMA), and isostearyl acrylate (iSTA). Among these C₄₋₂₀ alkyl (meth)acrylates, solely one species or a combination of two or more species can be used. For instance, the starting monomer mixture preferably comprises one or both of BA and 2EHA. In some embodiments, the starting monomer mixture preferably comprises at least BA. Examples of the starting monomer mixture comprising at least BA include a starting monomer mixture having a composition that comprises BA and is free of 2EHA, and a starting monomer mixture having a composition that comprises BA and 2EHA with the 2EHA content being less than the BA content (e.g., the 2EHA content being less than 0.5 times or 0.3 times the BA content).

In some embodiments, to facilitate balancing adhesive properties, the starting monomer mixture may include 40% (by weight) or more C₄₋₁₈ alkyl (meth)acrylate. The ratio of C₄₋₁₈ alkyl (meth)acrylate in the starting monomer mixture can be, for instance, 50% by weight or higher, 60% by weight or higher, or even 65% by weight or higher. From the standpoint of helping obtain a supple and durable PSA layer, the ratio of C₄₋₁₈ alkyl (meth)acrylate in the starting monomer mixture is suitably 99.5% by weight or lower; it can be 98% by weight or lower, or even 96% by weight or lower.

In addition to the alkyl (meth)acrylate, the starting monomer mixture used for preparing an acrylic polymer as the polymer (a1) may include, as necessary, another monomer (copolymerizable monomer) that is able to copolymerize with the alkyl (meth)acrylate. As the copolymerizable monomer, a monomer having a polar group (such as a carboxy group, a hydroxy group and a nitrogen atom-containing ring), a monomer having a benzophenone structure, or a monomer having a relatively high homopolymer glass transition temperature (e.g., 10° C. or higher) and the like may be suitably used. The monomer having a polar group may be useful for introducing crosslinking points (reactive functional groups (f1)) into the acrylic polymer or increasing the cohesive strength of the resin film. For the copolymerizable monomer, solely one species or a combination of two or more species can be used.

Non-limiting specific examples of the copolymerizable monomer include those indicated below.

Carboxy group-containing monomers: for example, acrylic acid, methacrylic acid, carboxyethyl acrylate, carboxypentyl acrylate, itaconic acid, maleic acid, fumaric acid, crotonic acid and isocrotonic acid;
Acid anhydride group-containing monomers: for example, maleic anhydride and itaconic anhydride;
Hydroxy group-containing monomers: for example, hydroxyalkyl (meth)acrylates such as 2-hydroxyethyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate and (4-hydroxymethylcyclohexyl)methyl (meth)acrylate;
Monomers having a sulphonate group or a phosphate group: for example, styrene sulphonic acid, allyl sulphonic acid, sodium vinylsulphonate, 2-(meth)acrylamide-2-methylpropane sulphonic acid, (meth)acrylamide propane sulphonic acid, sulphopropyl (meth)acrylate, (meth)acryloyloxy naphthalenesulphonic acid and 2-hydroxyethylacryloyl phosphate;
Epoxy group-containing monomers: for example, glycidyl (meth)acrylate, methyl glycidyl (meth)acrylate, and allyl glycidyl ether and (meth)acrylate glycidyl ether;
Cyano group-containing monomers: for example, acrylonitrile and methacrylonitrile;
Isocyanato group-containing monomers: for example, 2-isocyanatoethyl (meth)acrylate, (meth)acryloyl isocyanate, and m-isopropenyl-α,α-dimethylbenzyl isocyanate;
Amido group-containing monomers: for example, (meth)acrylamide; N,N-dialkyl (meth)acrylamides such as N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide and N,N-di(t-butyl) (meth)acrylamide; N-alkyl(meth)acrylamides such as N-ethyl(meth)acrylamide, N-isopropyl(meth)acrylamide, N-butyl(meth)acrylamide and N-n-butyl(meth)acrylamide; N-vinylcarboxylic acid amides such as N-vinylacetamide as well as N,N-dimethylaminopropyl(meth)acrylamide, etc.;
Amino group-containing monomers: for example, aminoethyl (meth)acrylate, N,N-dimethylaminoethyl (meth)acrylate and t-butylaminoethyl (meth)acrylate.

Monomers having a nitrogen atom-containing ring: for example, N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-(meth)acryloylmorpholine, N-vinylmorpholine, N-vinyl-3-morpholinone, N-vinyl-2-caprolactam, N-vinyl-1,3-oxazin-2-one, N-vinyl-3,5-morpholinedione, N-vinylpyrazole, N-vinylisoxazole, N-vinylthiazole, N-vinylisothiazole and N-vinylpyridazine (such as lactams including N-vinyl-2-caprolactam);
Monomers having a succinimide backbone: for example, N-(meth)acryloyloxy methylene succinimide, N-(meth)acryloyl-6-oxy hexamethylene succinimide and N-(meth)acryloyl-8-oxy hexamethylene succinimide;
Maleimides: for example, N-cyclohexylmaleimide, N-isopropylmaleimide, N-laurylmaleimide and N-phenylmaleimide;
Itaconimides: for example, N-methyl itaconimide, N-ethyl itaconimide, N-butyl itaconimide, N-octyl itaconimide, N-2-ethylhexyl itaconimide, N-cyclohexyl itaconimide and N-lauryl itaconimide;
Aminoalkyl (meth)acrylates: for example, aminoethyl (meth)acrylate, N,N-dimethylaminoethyl (meth)acrylate, N,N-diethylaminoethyl (meth)acrylate and t-butylaminoethyl (meth)acrylate;
Alkoxy group-containing monomers: for example, alkoxyalkyl (meth)acrylates such as 2-methoxyethyl (meth)acrylate, 3-methoxypropyl (meth)acrylate, 2-ethoxyethyl (meth)acrylate, propoxyethyl (meth)acrylate, butoxyethyl (meth)acrylate and ethoxypropyl (meth)acrylate; and alkoxy alkylene glycol (meth)acrylates such as methoxy ethylene glycol (meth)acrylate, methoxy poly(ethylene glycol) (meth)acrylate and methoxy poly(propylene glycol) (meth)acrylate;
Alkoxysilyl group-containing monomers: for example, alkoxysilyl group-containing (meth)acrylates such as (3-(meth)acryloxypropyl)trimethoxysilane, (3-(meth)acryloxypropyl)triethoxysilane, (3-(meth)acryloxypropyl)methyldimethoxysilane, (3-(meth)acryloxypropyl)methyldiethoxysilane; and alkoxysilyl group-containing vinyl compounds such as vinyltrimethoxysilane and vinyltriethoxysilane;
Vinyl esters: for example, vinyl acetate and vinyl propionate;
Vinyl ethers: for example, vinyl alkyl ethers such as methyl vinyl ether and ethyl vinyl ether;
Aromatic vinyl compounds: for example, styrene, α-methylstyrene and vinyl toluene;
Olefins: for example, ethylene, butadiene, isoprene and isobutylene;
(Meth)acrylic esters having alicyclic hydrocarbon groups: for example, alicyclic hydrocarbon group-containing (meth)acrylates such as cyclopentyl (meth)acrylate, cyclohexyl (meth)acrylate, isobornyl (meth)acrylate, dicyclopentanyl (meth)acrylate, and adamantyl (meth)acrylate;
(Meth)acrylic esters having aromatic hydrocarbon groups: for example, aromatic hydrocarbon group-containing (meth)acrylates such as phenyl (meth)acrylate, phenoxyethyl (meth)acrylate and benzyl (meth)acrylate;
Heterocyclic ring-containing (meth)acrylates such as tetrahydrofurfuryl (meth)acrylate, halogen atom-containing (meth)acrylates such as vinyl chloride and fluorine atom-containing (meth)acrylates, silicon atom-containing (meth)acrylates such as silicone (meth)acrylate, and (meth)acrylic esters obtained from terpene compound derivative alcohols.

Monomers having benzophenone structures: for example, (meth)acryloyloxybenzophenones such as 4-(meth)acryloyloxybenzophenone, 4-(meth)acryloyloxy-4′-methoxybenzophenone, and 4-acryloyloxy-4′-bromobenzophenone; (meth)acryloyloxybenzophenones such as 4-[(2-(meth)acryloyloxy)ethoxy]benzophenone and 4-[(2-(meth)acryloyloxy)ethoxy]-4′-bromobenzophenone; vinylbenzophenones such as 4-vinylbenzophenone and 4′-bromo-3-vinylbenzophenone.

When using such a copolymerizable monomer, its amount is not particularly limited, but it is typically suitably at least 0.01% by weight of the entire starting monomer mixture. From the standpoint of obtaining greater effect of the use of the copolymerizable monomer, the amount of copolymerizable monomer used can be 0.1% by weight or more of the entire starting monomer mixture, or even 0.5% by weight or more. For easy balancing of adhesive properties, the amount of copolymerizable monomer used is typically suitably 50% by weight or less of the entire starting monomer mixture, or preferably 40% by weight or less. When using, as the copolymerizable monomer, a monomer having reactive functional groups (f1) or a functional group (e.g., an undermentioned functional group A) used to introduce the reactive functional groups (f1), from the standpoint of facilitating the formation of the first network with a suitable crosslinking degree, the amount of the monomer is suitably 0.01% by weight or greater, preferably 0.1% by weight or greater, possibly 0.5% by weight or greater, 1% by weight or greater, 3% by weight or greater, or even 4% by weight or greater. For the same reason, it is suitably 30% by weight or less, preferably 25% by weight or less, possibly 20% by weight or less, 15% by weight or less, 10% by weight or less, or even 8% by weight or less.

In some embodiments, the first network forming the resin film may be formed, by using an acrylic polymer as the polymer (a1) (the acrylic polymer is prepared from a starting monomer mixture comprising a carboxy group-containing monomer) and by crosslinking the polymer (a1) by utilizing the carboxy groups of the acrylic polymer as the reactive functional groups (f1). From the standpoint of facilitating the control of crosslinked structure and crosslinking degree, the starting monomer mixture in this embodiment may have a composition free of a hydroxy group-containing monomer or a composition in which the amount of the hydroxy group-containing monomer is smaller than the amount of the carboxy group-containing monomer (e.g., a composition in which the amount of the hydroxy group-containing monomer is ½ the amount of the carboxy group-containing monomer or less, ¼ or less, or even 1/10 or less).

In an embodiment using carboxy groups as reactive functional groups (f1), the amount of the carboxy group-containing monomer in the starting monomer mixture for preparing the polymer (a1) is, for instance, suitably 0.5% by weight or more of the starting monomer mixture, preferably 1% by weight or more, more preferably 2% by weight or more, possibly 3% by weight or more, or even 4% by weight or more. In some embodiments, in view of the resin film's flexibility, low-temperature properties and the like, the amount of the carboxy group-containing monomer is advantageously 15% by weight or less, preferably 10% by weight or less, more preferably 8% by weight or less, possibly 7% by weight or less, or even 6% by weight or less.

The acrylic polymer as the polymer (a1) may have a photo-crosslinkable functional group as the reactive functional group (f1). Examples of the photo-crosslinkable functional group include ethylenically unsaturated groups such as (meth)acryloyl groups, vinyl groups and allyl groups; and benzophenone structures. An acrylic polymer having a benzophenone structure as the reactive functional group (f1) can be obtained, for instance, by using a monomer having a benzophenone structure as the copolymerizable monomer. An acrylic polymer having an ethylenically unsaturated group as the reactive functional group (f1) can be obtained, for instance, by polymerizing a starting monomer mixture and then modifying the resulting polymer with a compound having an ethylenically unsaturated group. For instance, a species having a functional group A is used as the copolymerizable monomer and the functional group A in the resulting polymer is allowed to react with a compound having an ethylenically unsaturated group and a functional group B. Preferable examples of the copolymerizable monomer with functional group A include hydroxy group-containing monomers, carboxy group-containing monomers, epoxy group-containing monomers, and isocyanate group-containing monomers. By using a hydroxy group-containing monomer as the copolymerizable monomer, a polymer having hydroxy groups is obtained. On the other hand, when an isocyanate group-containing monomer is used as the compound having an ethylenically unsaturated group, upon reaction of the hydroxy group (functional group A) of the polymer with the isocyanate group (functional group B) of the compound, an acrylic polymer having the ethylenically unsaturated groups of the compound can be obtained.

The method for polymerizing the starting monomer mixture is not particularly limited. Various conventionally known polymerization methods can be suitably employed. Examples of the polymerization method that can be suitably employed include thermal polymerization (typically carried out in the presence of a thermal polymerization initiator) such as solution polymerization, emulsion polymerization and bulk polymerization; photopolymerization (typically carried out in the presence of a photopolymerization initiator) involving irradiation of light such as UV rays; and radiation polymerization involving irradiation of radioactive rays such as β rays and γ rays. Two or more polymerization methods can be carried out in combination (e.g., stepwise).

As the solvent (polymerization solvent) for solution polymerization, one kind of solvent or a solvent mixture of two or more kinds can be used, selected among, for instance, aromatic compounds (typically aromatic hydrocarbons) such as toluene; esters such as ethyl acetate and butyl acetate; aliphatic or alicyclic hydrocarbons such as hexane and cyclohexane; halogenated alkanes such as 1,2-dichloroethane; lower alcohols (e.g. monohydric alcohols with 1 to 4 carbon atoms) such as isopropanol; ethers such as tert-butyl methyl ether; and ketones such as methyl ethyl ketone.

In the polymerization, a known or commonly used thermal polymerization initiator or photopolymerization initiator can be used in accordance with the polymerization method and polymerization conditions. These polymerization initiators can be used solely as one species or in a combination of two or more species.

The thermal polymerization initiator is not particularly limited. For example, azo-based polymerization initiator, peroxide-based polymerization initiator, a redox-based polymerization initiator by combination of a peroxide and a reducing agent, substituted ethane-based polymerization initiator and the like can be used. More specific examples include, but not limited to, azo-based initiators such as 2,2′-azobisisobutyronitrile (AIBN), 2,2′-azobis(2-methylpropionamidine) disulfate, 2,2′-azobis(2-amidinopropane) dihydrochloride, 2,2′-azobis[2-(5-methyl-2-imidazolin-2-yl)propane] dihydrochloride, 2,2′-azobis(N,N′-dimethyleneisobutylamidine), and 2,2′-azobis[N-(2-carboxyethyl)-2-methylpropionamidine] hydrate; persulfates such as potassium persulfate and ammonium persulfate; peroxide-based initiators such as benzoyl peroxide, t-butyl hydroperoxide, and hydrogen peroxide; substituted ethane-based initiators such as phenyl-substituted ethane; redox-based initiators such as combination of a persulfate salt and sodium hydrogen sulfite, and combination of a peroxide and sodium ascorbate. Thermal polymerization can be preferably carried out at a temperature of, for instance, about 20° C. to 100° C. (typically 40° C. to 80° C.) while not limited to these ranges.

The photopolymerization initiator is not particularly limited. It is possible to use, for instance, ketal-based photopolymerization initiators, acetophenone-based photopolymerization initiators, benzoin ether-based photopolymerization initiators, acylphosphine oxide-based photopolymerization initiators, α-ketol photopolymerization initiators, aromatic sulphonyl chloride-based photopolymerization initiators, photoactive oxime-based photopolymerization initiators, benzoin-based photopolymerization initiators, benzylic photopolymerization initiators, benzophenone-based photopolymerization initiators, and thioxanthone-based photopolymerization initiators.

Such photopolymerization initiator can be used in a usual amount in accordance with the polymerization method, embodiment of polymerization, etc., and there are no particular limitations to the amount. For instance, relative to 100 parts by weight of monomers to be polymerized, about 0.001 part to 5 parts by weight (typically about 0.01 part to 2 parts by weight, e.g. about 0.01 part to 1 part by weight) of polymerization initiator can be used.

In the polymerization, various kinds of heretofore known chain transfer agent (which may also be thought as molecular weight-adjusting agent or polymerization degree-adjusting agent) can be used as necessary. As the chain transfer agent, mercaptans can be preferably used, such as n-dodecyl mercaptan, t-dodecyl mercaptan, thioglycolic acid and α-thioglycerol. Alternatively, a chain transfer agent free of sulfur atoms (a sulfur-free chain transfer agent) can be used as well. Specific examples of the sulfur-free chain transfer agent include anilines such as N,N-dimethylaniline and N,N-diethylaniline; terpenoids such as α-pinene and terpinolene; styrenes such as α-methylstyrene and α-methylstyrene dimer; compounds having benzylidenyl groups such as dibenzylidene acetone, cinnamyl alcohol and cinnamyl aldehyde; hydroquinones such as hydroquinone and naphthohydroquinone; quinones such as benzoquinone and naphthoquinone; olefins such as 2,3-dimethyl-2-butene and 1,5-cyclooctadiene; alcohols such as phenol, benzyl alcohol and allyl alcohol; and benzyl hydrogens such as diphenylbenzene and triphenylbenzene. For the chain transfer agent, solely one species or a combination of two or more species can be used. When using a chain transfer agent, its amount relative to 100 parts by weight of the starting monomer mixture can be, for instance, 0.005 part by weight or greater, 0.01 part by weight or greater, 0.05 part by weight or greater, or 0.07 part by weight or greater; and, for instance, 0.5 part by weight or less, 0.2 part by weight or less, 0.1 part by weight or less, or even less than 0.1 part by weight. The art disclosed herein can also be preferably implemented in an embodiment that uses no chain transfer agent.

The Mw of the acrylic polymer as the polymer (a1) can be, for instance, above about 20×10⁴, above 40×10⁴, or even above 60×10⁴. From the standpoint of readily obtaining a supple and durable resin film (e.g., a resin film having a stress integral value of greater than 10 MPa), in some embodiments, the acrylic polymer's Mw is advantageously above 70×10⁴, preferably 80×10⁴ or higher (e.g., above 80×10⁴), possibly 90×10⁴ or higher, 100×10⁴ or higher, 120×10⁴ or higher, or even 140×10⁴ or higher. The acrylic polymer's Mw can be, for instance, 500×10⁴ or lower. For facilitating the formation of a structure in which the first and second networks are suitably interlaced, it is preferably 300×10⁴ or lower, possibly 200×10⁴ or lower, 180×10⁴ or lower, 150×10⁴ or lower, or even 120×10⁴ or lower.

The glass transition temperature (Tg) of the acrylic polymer as the polymer (a1) is not particularly limited. To make it easy to obtain suitable flexibility as a PSA sheet or its constituent, in some embodiments, the acrylic polymer's Tg is suitably 40° C. or lower, preferably 30° C. or lower, more preferably 25° C. or lower, possibly 20° C. or lower, or even 15° C. or lower. In the resin film used as a PSA layer (especially, a PSA layer forming the adhesive surface), for the ease of application work to the adherend, the acrylic polymer's Tg is suitably 10° C. or lower, advantageously below 0° C., preferably below −10° C., or more preferably below −20° C. In some embodiments, the acrylic polymer's Tg can be below −25° C., below −30° C., below −40° C., or even below −45° C. From the standpoint of readily obtaining a supple and durable resin film, the acrylic polymer's Tg is suitably −80° C. or higher, preferably −70° C. or higher, possibly −60° C. or higher, or even −55° C. or higher. In some embodiments, the acrylic polymer's Tg can be −40° C. or higher, −20° C. or higher, −10° C. or higher, or even 0° C. or higher. In some embodiments of the resin film used as a substrate film, from the standpoint of the ease of handling, processing, etc., it is preferable to use an acrylic polymer having a relatively high Tg (e.g., −20° C. or higher).

As used herein, the polymer's Tg refers to the Tg value determined by the Fox equation based on the composition of the starting monomer mixture used to prepare the polymer unless otherwise noted. As shown below, the Fox equation is a relational expression between the Tg of a copolymer and glass transition temperatures Tgi of homopolymers of the respective monomers constituting the copolymer.

1/Tg=Σ(Wi/Tgi)

In the Fox equation above, Tg represents the glass transition temperature (unit: K) of the copolymer, Wi the weight fraction (copolymerization ratio by weight) of a monomer i in the copolymer, and Tgi the glass transition temperature (unit: K) of homopolymer of the monomer i. When the polymer subject to Tg determination is a homopolymer, the Tg values of the homopolymer and the subject polymer are the same.

As the glass transition temperatures of homopolymers used for determining the Tg value, values found in publicly known documents are used. For example, with respect to the monomers listed below, as the glass transition temperatures of homopolymers of the monomers, the following values are used:

| | | |
|---|---|---|
| 2-ethylhexyl acrylate | −70° | C. |
| n-butyl acrylate | −55° | C. |
| methyl methacrylate | 105° | C. |
| methyl acrylate | 8° | C. |
| 2-hydroxyethyl acrylate | −15° | C. |
| 2- hydroxyethyl methacrylate | 55° | C. |
| 4-hydroxybutyl acrylate | −40° | C. |
| acrylic acid | 106° | C. |
| methacrylic acid | 228° | C. |

With respect to the glass transition temperatures of homopolymers of monomers other than those listed above, values given in “Polymer Handbook” (3rd edition, John Wiley & Sons, Inc., Year 1989) are used. When the literature provides two or more values, the highest value is used. When no glass transition temperatures of the corresponding homopolymers are given in Polymer Handbook, values obtained by the measurement method described in Japanese Patent Application Publication No. 2007-51271 are used. With respect to polymers whose nominal glass transition temperatures are provided by makers, etc., the nominal values may also be used.

In the embodiment in which the polymer (a1) is an acrylic polymer, the stress integral value of the resin film can be, for instance, 500 MPa or less, 300 MPa or less, 100 MPa or less, or even 80 MPa or less. In the resin film used as a PSA layer (especially, a PSA layer forming the adhesive surface) in a PSA sheet, for the ease of application work to the adherend, the stress integral value is suitably 70 MPa or less, preferably 60 MPa or less, possibly 50 MPa or less, 40 MPa or less, or even 30 MPa or less.

### (Polyester-Based Polymer)

In other preferable embodiments, the polymer (a1) is a polyester-based polymer. The polyester-based polymer typically has a structure resulting from condensation of a polycarboxylic acid (dicarboxylic acid, etc.) or its derivative (referred to as a “polycarboxylic acid monomer” hereinafter) and a polyalcohol (diol, etc.) or its derivative (referred to as a “polyalcohol monomer” hereinafter).

The polycarboxylic acid monomer is not particularly limited. For instance, it is possible to use aromatic dicarboxylic acids such as isophthalic acid, terephthalic acid, orthophthalic acid, benzylmalonic acid, 2,2′-biphenyl dicarboxylic acid, 4,4′-biphenyl dicarboxylic acid, 4,4′-dicarboxydiphenyl ether, and naphthalene dicarboxylic acid; alicyclic dicarboxylic acids such as 1,2-cyclopentane dicarboxylic acid, 1,4-cyclohexane dicarboxylic acid, 1,3-cyclohexane dicarboxylic acid, 1,2-cyclohexane dicarboxylic acid, 4-methyl-1,2-cyclohexane dicarboxylic acid, norbornane dicarboxylic acid, and adamantane dicarboxylic acid; aliphatic dicarboxylic acids such as malonic acid, succinic acid, glutaric acid, dimethyl glutaric acid, adipic acid, trimethyladipic acid, pimelic acid, suberic acid, azelaic acid, sebacic acid, dodecanedioic acid, thiopropionic acid, and diglycolic acid; unsaturated dicarboxylic acids such as maleic acid, maleic acid anhydride, fumaric acid, itaconic acid, and citraconic acid, hexahydrophthalic acid anhydride, tetrahydrophthalic acid anhydride, and dodecenyl phthalic acid anhydride; tri- or higher polycarboxylic acids such as trimellitic acid, pyromellitic acid, adamantane tricarboxylic acid, and trimesic acid; dimer acids and trimer acids derived from aliphatic acids such as oleic acid; and derivatives of these. The derivatives of polycarboxylic acids include derivatives such as carboxylic acid salts, carboxylic acid anhydrides, halogenated carboxylic acids, and carboxylic acid esters. For the polyfunctional carboxylic acid monomer, solely one species or a combination of two or more species can be used. From the standpoint of providing suitable cohesive strength to the resin film, it preferably comprises an aromatic dicarboxylic acid. Especially, it preferably comprises one or both of terephthalic acid and isophthalic acid.

The polyalcohol monomer is not particularly limited. For instance, it is possible to use aliphatic diols such as ethylene glycol, diethylene glycol, triethylene glycol, 1,2-propylene glycol, dipropylene glycol, 1,3-propanediol, 2-methyl-1,3-propanediol, 2,2-dimethyl-1,3-propanediol (neopentyl glycol), 2-ethyl-2-butyl-1,3-propanediol, 2-ethyl-2-isobutyl-1,3-propanediol, 1,2-butanediol, 1,3-butanediol, 1,4-butanediol, 1,5-pentanediol, 3-methyl-1,5-pentanediol, 2,2,4-trimethyl-1,5-pentanediol, 1,6-hexanediol, 2-methyl-1,3-hexanediol, 2,2,4-trimethyl-1,6-hexanediol, 1,8-octanediol, 1,9-nonanediol, 2-methyloctanediol, and 1,10-decanediol; alicyclic diols such as 1,2-cyclohexanedimethanol, 1,3-cyclohexanedimethanol, 1,4-cyclohexanedimethanol, spiroglycol, tricyclodecanedimethanol, adamantane diol, 2,2,4,4-tetramethyl-1,3-cyclobutanediol; aromatic diols such as 4,4′-thiodiphenol, 4,4′-methylenediphenol, 4,4′-dihydroxybiphenyl, o-, m- and p-dihydroxybenzenes, 2,5-naphthalenediol, p-xylenediol as well as ethylene oxide and propylene oxide adducts of these; dimer diols; and tri- or higher polyalcohols such as pentaerythritol, dipentaerythritol, tripentaerythritol, glycerin, trimethylolpropane, trimethylolethane, 1,3,6-hexanetriol, and adamantanetriol; derivatives of these; and the like. For the polyalcohol monomer, solely one species or a combination of two or more species can be used. It preferably comprises an aliphatic and/or alicyclic diol. It more preferably comprises one, two or more among polytetramethylene glycol, neopentyl glycol and cyclohexanedimethanols.

The method for obtaining the polyester-based polymer is not particularly limited. A polymerization method known as a synthetic method of polyester-based polymer can be suitably employed. With respect to the starting monomers used for synthesizing the polyester-based polymer, from the standpoint of the polymerization efficiency, molecular weight adjustment, etc., it is suitable that at least one equivalent (e.g., one to two equivalents) of polyalcohol monomer is added to one equivalent of polycarboxylic acid monomer. In a preferable embodiment, the amount of polyalcohol monomer added to one equivalent of polycarboxylic acid monomer is more than one equivalent up to 1.8 equivalents (e.g., 1.2 to 1.7 equivalents).

The polyester-based polymer used as the polymer (a1) can be obtained by polycondensation of a polycarboxylic acid monomer and a polyalcohol monomer, similar to general polyesters. More specifically, the polyester-based polymer can be synthesized by carrying out the reaction between the carboxy group of the polycarboxylic acid monomer and the hydroxy group of the polyalcohol monomer, in typical, while removing the water (byproduct water) formed in the reaction out of the reaction system. The byproduct water can be removed from the reaction system by a method where an inert gas is introduced into the reaction system to force the byproduct water out of the reaction system along with the inert gas, by a method (reduced pressure method) where the byproduct water is removed by evaporation from the reaction system under reduced pressure, or by like method. The reduced pressure method can be preferably employed as it is likely to reduce the time for synthesis and is suited for increasing the productivity.

The reaction temperature for carrying out the reaction (including esterification and polycondensation) as well as the extent of pressure reduction (the pressure inside the reaction system) when the reduced pressure method is employed can be suitably selected so as to efficiently obtain a polyester-based polymer with desired properties (e.g., molecular weight). While no particular limitations are imposed, the reaction temperature is usually suitably 180° C. to 260° C., for instance, 200° C. to 220° C. When the reaction temperature is in these ranges, a good reaction rate is obtained with increased productivity and degradation of the resulting polyester-based polymer is readily prevented or inhibited. While no particular limitations are imposed, the pressure inside is usually suitably 10 kPa or lower (typically 10 kPa to 0.1 kPa), for instance, possibly 4 kPa to 0.1 kPa. When the pressure inside the reaction system is in these ranges, the water formed in the reaction can be efficiently removed by evaporation from the system to maintain a good reaction rate. When the reaction temperature is relatively high, the pressure inside the reaction system is maintained at or above the lower limit to readily prevent elimination of the starting polycarboxylic acid monomer and polyalcohol monomer by evaporation from the system. From the standpoint of stably maintaining the pressure inside the reaction system, the pressure inside the reaction system is usually suitably 0.1 kPa or higher.

In the reaction, similar to general polyester synthesis, a known or commonly-used catalyst can be used in a suitable amount for esterification and condensation. Examples of the catalyst include various metal compounds based on titanium, germanium, antimony, tin, zinc, etc.; and strong acids such as p-toluenesulfonic acid and sulfuric acid. Among them, the use of a titanium-based metallic compound (titanium compound) is preferable. Specific examples of the titanium compound include titanium tetraalkoxides such as titanium tetrabutoxide, titanium tetraisopropoxide, titanium tetrapropoxide and titanium tetraethoxide; alkyl titanates such as tetraisopropyl titanate, tetrabutyl titanate, octaalkyl trititanate and hexaalkyl dititanate; and titanium acetate.

A solvent may or may not be used in the process of synthesizing the polyester-based polymer by the reaction of polycarboxylic acid monomer and polyalcohol monomer. The synthesis can be carried out, using essentially no organic solvent (e.g., it means to exclude an embodiment where an organic solvent is purposefully used as the reaction solvent during the reaction). It is preferable to synthesize the polyester-based polymer using essentially no organic solvent and prepare a polyester-based PSA using the polyester-based polymer because it matches the desire to reduce the use of organic solvents in the production process.

It is noted that there is a correlation between the molecular weight of the polyester-based polymer being synthesized and the viscosity of the reaction mixture; and therefore, during the reaction, this can be taken advantage of to manage the molecular weight of the polyester-based polymer. For instance, the stirrer's torque and the reaction mixture's viscosity can be continuously or intermittently measured (monitored) during the reaction to precisely synthesize a polyester-based polymer that meats the target molecular weight.

The hydroxyl value of the polyester-based polymer used as the polymer (a1) is not particularly limited. It can be 0 mgKOH/g, greater than 0 mgKOH/g, or 1 mgKOH/g or greater. In the design of forming the first network where a polyester-based polymer with hydroxy groups is used and the hydroxy groups are used as reactive functional groups (f1) to crosslink the polymer (a1), it is preferable to use a polyester-based polymer having a hydroxyl value greater than 1 mgKOH/g. The polyester-based polymer with hydroxy groups can be crosslinked, using a compound (e.g., isocyanate-based crosslinking agent) having two or more functional groups that are reactive with the hydroxy groups. From the standpoint of facilitating the formation of the first network having a crosslinking degree suited for obtaining a supple and durable resin film, in some embodiments, the hydroxyl value of the polyester-based polymer is, for, instance, suitably 2 mgKOH/g or greater, preferably 3 mgKOH/g or greater, possibly 4 mgKOH/g or greater, or even 6 mgKOH/g or greater. For the same reason, the hydroxyl value of the polyester-based polymer is, for, instance, suitably less than 30 mgKOH/g, preferably less than 20 mgKOH/g, possibly less than 15 mgKOH/g, less than 12 mgKOH/g, or even less than 10 mgKOH/g.

The acid value of the polyester-based polymer used as the polymer (a1) is not particularly limited. In the design of forming the first network where a polyester-based polymer with carboxy groups is used and the carboxy groups are used as reactive functional groups (f1) to crosslink the polymer (a1), it is preferable to use a polyester-based polymer having an acid value greater than 1 mgKOH/g. The polyester-based polymer with carboxy groups can be crosslinked, using a compound (e.g., epoxy-based crosslinking agent) having two or more functional groups that are reactive with the carboxy groups. From the standpoint of facilitating the formation of the first network having a crosslinking degree suited for obtaining a supple and durable resin film, in some embodiments, the acid value of the polyester-based polymer is, for, instance, suitably 0.1 mgKOH/g or greater, preferably 0.5 mgKOH/g or greater, possibly 1.0 mgKOH/g or greater, or even 2.0 mgKOH/g or greater. For the same reason, the acid value of the polyester-based polymer is, for, instance, suitably less than 30 mgKOH/g, preferably less than 20 mgKOH/g, possibly less than 15 mgKOH/g, less than 12 mgKOH/g, or even less than 10 mgKOH/g.

In the design where hydroxy groups are used as reactive functional groups (f1) to crosslink the polyester-based polymer, from the standpoint of facilitating the control of crosslinked structure and crosslinking degree, the acid value of the polyester-based polymer is suitably less than the hydroxyl value of the polymer. For instance, it is preferably ½ the hydroxyl value or less, or more preferably ⅓ or less. In the design where carboxy groups are used as reactive functional groups (f1) to crosslink the polyester-based polymer, from the standpoint of facilitating the control of crosslinked structure and crosslinking degree, the hydroxyl value of the polyester-based polymer is suitably less than the acid value of the polymer. For instance, it is preferably ½ the acid value or less, or more preferably ⅓ or less.

The hydroxyl value and acid value of a polyester-based polymer can be determined based on JIS K0070:1992. If there is a nominal value provided by the manufacturer, etc., it can be used.

The number average molecular weight (Mn) of the polyester-based polymer as the polymer (a1) is not particularly limited and can be, for instance, about 5000 or higher. From the standpoint of readily obtaining a supple and durable resin film (e.g., a resin film having a stress integral value of greater than 10 MPa), in some embodiments, the polyester-based polymer's Mn is preferably about 7000 or higher, more preferably about 9000 or higher, for instance, possibly about 12000 or higher, about 15000 or higher, about 18000 or higher, or even about 21000 or higher (e.g., about 24000 or higher). The polyester-based polymer's Mn is typically suitably about 10×10⁴ or lower. For facilitating the formation of a structure in which the first and second networks are suitably interlaced, it is preferably about 7×10⁴ or lower, more preferably about 5×10⁴ or lower, for instance, possibly about 4×10⁴ or lower, or even about 3×10⁴ or lower.

The Tg of the polyester-based polymer as the polymer (a1) is not particularly limited and can be, for instance, about 90° C. or lower. To make it easy to obtain suitable flexibility as a PSA sheet or its constituent, in some embodiments, the polyester-based polymer's Tg is suitably about 80° C. or lower, preferably 60° C. or lower, possibly 50° C. or lower, or even 40° C. or lower. In the resin film used as a PSA layer (especially, a PSA layer forming the adhesive surface), for the ease of application work to the adherend, the polyester-based polymer's Tg is advantageously below about 15° C., preferably below about 10° C., more preferably below about 0° C., for instance, possibly below about −5° C., below about −10° C., or even below about −15° C. From the standpoint of readily obtaining a supple and durable resin film, the polyester-based polymer's Tg is suitably about −70° C. or higher, preferably about −60° C. or higher, more preferably about −50° C. or higher, or yet more preferably about −40° C. or higher (e.g., −30° C. or higher).

The polyester-based polymer's Tg can be determined using a commercially available differential scanning calorimeter (e.g., instrument name DSC Q20 available from TA Instruments). The measurement is taken while applying shear strain at a frequency of 1 Hz over a temperature range of −90° C. to 100° C. at a heating rate of 10° C./min. If there is a nominal value provided by the manufacturer, etc., it can be used.

### (Crosslinking Agent)

For crosslinking to form the first network from the polymer (a1) (e.g., an acrylic polymer, polyester-based polymer), a crosslinking agent can be used as necessary. In the resin sheet disclosed herein, the crosslinking agent used for crosslinking of polymer (a1) is included typically in a crosslinked form (e.g., incorporated as a crosslinked residue in the first network). By suitably selecting the species and amount of crosslinking agent in accordance with the species of reactive functional group (f1) of the polymer (a1) and the amount thereof, it is possible to form the first network suitable for obtaining a supple and durable resin sheet.

Examples of the crosslinking agent that can be used for crosslinking of polymer (a1) include epoxy-based crosslinking agent, isocyanate-based crosslinking agent, oxazoline-based crosslinking agent, aziridine-based crosslinking agent, carbodiimide-based crosslinking agent, melamine-based crosslinking agent, urea-based crosslinking agent, metal alkoxide-based crosslinking agent, metal chelate-based crosslinking agent, metal salt-based crosslinking agents, hydrazine-based crosslinking agent, and amine-based crosslinking agent. These can be used solely as one species or in a combination of two or more species.

As the epoxy-based crosslinking agent, a polyfunctional epoxy compound having two or more epoxy groups per molecule can be used without particular limitations. A preferable epoxy-based crosslinking agent has 3 to 5 epoxy groups per molecule. Specific examples of the epoxy-based crosslinking agent include N,N,N′,N′-tetraglycidyl-m-xylenediamine, 1,3-bis(N,N-diglycidylaminomethyl)cyclohexane, 1,6-hexanediol diglycidyl ether, polyethylene glycol diglycidyl ether, and polyglycerol polyglycidyl ether. Examples of commercial epoxy-based crosslinking agents include product names TETRAD-C and TETRAD-X available from Mitsubishi Gas Chemical Co., Inc.; product name EPICLON CR-5L available from DIC Corp.; product name DENACOL EX-512 available from Nagase ChemteX Corporation; and product name TEPIC-G available from Nissan Chemical Industries, Ltd.

As the isocyanate-based crosslinking agent, a bifunctional or higher polyfunctional isocyanate compound can be used. Examples include aromatic isocyanates such as tolylene diisocyanate, xylene diisocyanate, polymethylene polyphenyl diisocyanate, tris (p-isocyanatophenyl)thiophosphate, and diphenylmethane diisocyanate; alicyclic isocyanates such as isophorone diisocyanate; and aliphatic isocyanates such as hexamethylene diisocyanate. Commercial products include isocyanate adducts such as trimethylolpropane/tolylene diisocyanate trimer adduct (trade name CORONATE L available from Tosoh Corporation), trimethylolpropane/hexamethylene diisocyanate trimer adduct (trade name CORONATE HL available from Tosoh Corporation), and isocyanurate of hexamethylene diisocyanate (trade name CORONATE HX available from Tosoh Corporation) and trimethylolpropane/xylylene diisocyanate adduct (product name TAKENATE D-110N available from Mitsui Chemicals, Inc.).

As the oxazoline-based crosslinking agent, a species having one or more oxazoline groups in one molecule can be used without particular limitations.

Examples of the aziridine-based crosslinking agent include trimethylolpropane tris[3-(1-aziridinyl)propionate] and trimethylolpropane tris[3-(1-(2-methyl) aziridinylpropionate)].

As the carbodiimide-based crosslinking agent, a low molecular weight compound or a high molecular weight compound having two or more carbodiimide groups can be used.

In an embodiment using a crosslinking agent to form the first network, the amount of the crosslinking agent is not particularly limited and can be suitably selected to obtain a supple and durable resin sheet. For instance, the amount of crosslinking agent used per 100 parts by weight of polymer (a1) can be selected in the range of 0.001 part to 10 parts (e.g., 0.01 part to 5 parts) by weight. With increasing amount of crosslinking agent, the first network will be denser and the breaking stress of the resin film tends to increase. With decreasing amount of crosslinking agent, the first network will be sparser and the breaking elongation of the resin film tends to increase.

In some embodiments using an epoxy-based crosslinking agent to form the first network, the amount of epoxy-based crosslinking agent used per 100 parts by weight of polymer (a1) can be, for instance, 0.001 part by weight or greater, 0.005 part by weight or greater, or even 0.01 part by weight or greater. The amount of epoxy-based crosslinking agent can be, for instance, 1 part by weight or less, 0.5 part by weight or less, 0.1 part by weight or less, or even 0.05 part by weight or less. In some embodiments using an isocyanate-based crosslinking agent to form the first network, the amount of isocyanate-based crosslinking agent used per 100 parts by weight of polymer (a1) can be, for instance, 1 part by weight or less, 0.5 part by weight or less, 0.1 part by weight or less, or even 0.05 part by weight or less.

The resin film disclosed herein can also be made in an embodiment not using a crosslinking agent to form the first network. The polymer (a1) can be crosslinked to form the first network, for instance, by radical reaction, addition reaction, condensation reaction and so on using the reactive functional groups (f1) (which can be several different functional groups) of the polymer (a1). In an embodiment where the polymer (a1) is crosslinked by radical reaction, it is preferable to use a polymer (a1) having an ethylenically unsaturated group as the reactive functional group (f1).

### <Second Network>

(Polyfunctional Monomer (b1))

The second network is preferably a cured product of a second material. For instance, a second material comprising a polyfunctional monomer (b1) is used and the polyfunctional monomer (b1) can be allowed to react to cure the second material and form the second network. As the polyfunctional monomer (b1), a compound that has two or more reactive functional groups (C) per molecule can be used. The reactive functional groups (C) can be the same or a different kind of functional group as the reactive functional group (f1) that may be in the polymer (a1). As the polyfunctional monomer, solely one species or a combination of two or more species can be used.

In some embodiments, the polyfunctional monomer (b1) can be a compound that has, as the reactive functional group (C), two or more ethylenically unsaturated groups per molecule. Examples of the polyfunctional monomer (b1) include polyfunctional (meth)acrylates; polyfunctional vinyl compounds such as divinylbenzene; and a compound having a vinyl group and a (meth)acryloyl group in one molecule, such as allyl (meth)acrylate, vinyl (meth)acrylate, butanediol (meth)acrylate, and hexanediol di(meth)acrylate. Among them, polyfunctional (meth)acrylates are preferable.

In other examples, the polyfunctional monomer (b1) can be a compound that has two or more reactive functional groups (C) that are not ethylenically unsaturated groups per molecule. Examples of the reactive functional group (C) other than the ethylenically unsaturated groups include an isocyanate group, epoxy group, alkoxysilyl group, hydroxy group, carboxy group, and amino group. As the reactive functional group (C), for instance, the abovementioned various polyfunctional isocyanate compounds, polyfunctional epoxy compounds and the like can be used. In particular, polyfunctional isocyanate compounds are preferable.

Other examples of the polyfunctional monomer (b1) include a compound that has an ethylenically unsaturated group and a reactive functional group (C) that is not an ethylenically unsaturated group in one molecule. In one molecule of such a compound, the number of ethylenically unsaturated groups can be one, two or higher; the same is true with the number of reactive functional groups other than the ethylenically unsaturated groups.

The reactive functional group (f1) of the polymer (a1) in the first material can be the same kind as or a different kind from the reactive functional group (f2) of the polyfunctional monomer (b1) in the second material. In some embodiments, from the standpoint of the ease of controlling the formation of the first network and/or the second network, etc., it is possible to employ an embodiment in which the reactive functional groups (f1) and (f2) are of different types. Examples of a combination of reactive functional groups (f1) and (f2) include, but are not limited to, an embodiment where the reactive functional group (f1) is a carboxy group and the reactive functional group (f2) is an ethylenically unsaturated group; an embodiment where the reactive functional group (f1) is a carboxy group and the reactive functional group (f2) is an isocyanate group; an example where the reactive functional group (f1) is an ethylenically unsaturated group and the reactive functional group (f2) is an isocyanate group; and an embodiment where the reactive functional group (f1) is a hydroxy group and the reactive functional group (f2) is an ethylenically unsaturated group;

The number of reactive functional groups (f2) per molecule of polyfunctional monomer (b1) is not particularly limited as long as it is 2 or more. For instance, it can be about 2 to 20. When the number of reactive functional groups (f2) per molecule of polyfunctional monomer (b1) is not excessively high, the second network is prevented from being locally too dense, and the copresence of the interlaced first and second networks tends to effectively disperse stress. In other words, it helps obtain a network structure suited for realizing a supple and durable resin film. From such a standpoint, in some embodiments, the number of reactive functional groups (f2) per molecule of polyfunctional monomer (b1) is suitably less than 6.0, preferably less than 4.5, more preferably less than 4.0, or possibly less than 3.5.

Here, the number of reactive functional groups (f2) per molecule of polyfunctional monomer (b1) indicates, in an embodiment using only one species of compound as the polyfunctional monomer (b1), the number of reactive functional groups (f2) in one molecule of the compound. In an embodiment using two or more species of compounds differing in number of reactive functional groups (f2) per molecule, it indicates their average number of functional groups. The average number of functional groups is determined by the next equation:

Average number of functional groups=Σ(Ni×Wi)

In this equation, Ni is the number of reactive functional groups (f2) in one molecule of a compound i used as the polyfunctional monomer (b1), and Wi is the weight fraction of the compound i in the entire polyfunctional monomer(s) (b1). In other words, the average number of functional groups is determined as the sum of the product of the number of reactive functional groups (f2) in one molecule of each compound used as the polyfunctional monomer (b1) and the weight fraction of the compound in the entire polyfunctional monomer(s) (b1).

From the standpoint of inhibiting local excessive densification in the second network, in some embodiments, the polyfunctional monomer (b1) is preferably essentially free of a compound having 6 or more reactive functional groups (f2) per molecule, or more preferably essentially free of a compound having 4 or more reactive functional groups (f2) per molecule. Here, the term “essentially” indicates that it is not used at least intentionally, allowing for unintentional contamination of a small amount of a compound having at least a certain number of reactive functional groups (f2) as an impurity in the starting materials.

The molecular weight of the polyfunctional monomer (b1) is not particularly limited and can be selected to favorably bring about desirable effects. For instance, as the polyfunctional monomer (b1), a species having a molecular weight in the range between about 100 and 20000 can be used. The polyfunctional monomer (b1) may have a molecular weight below 16000 or even below 10000. From the standpoint of facilitating the formation of the second network that is suitably interlaced with the first network, in some embodiments, the molecular weight of the polyfunctional monomer (b1) is preferably below 5000, more preferably below 3000, possibly below 1500, below 1200, or even below 900. From the standpoint of facilitating the formation of the second network that suitably allows for deformation of the first network, in some embodiments, the molecular weight of the polyfunctional monomer (b1) is suitably 200 or higher, preferably 300 or higher, more preferably 400 or higher, possibly 500 or higher, or even 600 or higher.

Here, the molecular weight of the polyfunctional monomer (b1) means, in an embodiment using only one species of compound as the polyfunctional monomer (b1), the molecule weight of the compound. In an embodiment using two or more compounds with different molecular weights, it means their average molecular weight. The average molecular weight is determined by the next equation:

Average molecular weight=Σ(Mi×Wi)

In this equation, Mi is the molecular weight of a compound i used as the polyfunctional monomer (b1), and Wi is the weight fraction of the compound i in the entire polyfunctional monomer (b1). In other words, the average molecular weight is determined as the sum of the product of the molecular weight of each compound used as the polyfunctional monomer (b) and the weight fraction of the compound in the entire polyfunctional monomer(s) (b1).

As for the molecular weight of a compound used as the polyfunctional monomer (b1), with respect to a non-polymer or a compound including a repeating structure with a low degree of polymerization (e.g., dimer to pentamer), it is possible to use the molecular weight (chemical formula weight) calculated based on the chemical structure, or a measurement value based on matrix-assisted laser desorption ionization mass spectrometry (MALDI-TOF-MS). When the compound used as the polyfunctional monomer (b1) is a compound including a repeating structure with a higher degree of polymerization, it is possible to use the weight average molecular weight (Mw) based on GPC conducted under suitable conditions. If the manufacturer or the like provides a nominal value, that value can be used. The same applies to the molecular weight of the monofunctional monomer (b2) described later.

The functional group equivalent of the polyfunctional monomer (b1) is not particularly limited and can be selected to favorably bring about desirable effects. The functional group equivalent of the polyfunctional monomer (b1) is determined by dividing its molecular weight by the number of reactive functional groups (f1) therein. As the molecular weight of the polyfunctional monomer (b1), the value described above is used. From the standpoint of facilitating the formation of the second network that suitably allows for deformation of the first network, in some embodiments, the functional group equivalent of the polyfunctional monomer (b1) is suitably 100 or higher, preferably 150 or higher, more preferably 200 or higher, possibly 250 or higher, or even 300 or higher. The functional group equivalent of the polyfunctional monomer (b1) can be, for instance, lower than 5000. From the standpoint of facilitating the formation of the second network that is suitably interlaced with the first network, it is advantageously lower than 2500, preferably lower than 1000, more preferably lower than 800, possibly lower than 600, lower than 400, lower than 350, or even lower than 250.

Here, the functional group equivalent of the polyfunctional monomer (b1) means, in an embodiment using only one species of compound as the polyfunctional monomer (b1), the functional group equivalent of the compound. In an embodiment using two or more compounds with different molecular weights, it means their average functional group equivalent. The average functional group equivalent is determined by the next equation:

Average functional group equivalent=Σ((Mi/Ni)×Wi)

In this equation, Mi is the molecular weight of a compound i used as the polyfunctional monomer (b1), Ni is the number of reactive functional groups (f2) in one molecule of the compound i, and Wi is the weight fraction of the compound i in the entire polyfunctional monomer (b1). In other words, the average functional group equivalent is determined as the sum of the product of the functional group equivalent of each compound used as the polyfunctional monomer (b1) and the weight fraction of the compound in the entire polyfunctional monomer(s) (b1).

### (Polyfunctional (Meth)Acrylate)

In some embodiments, a bifunctional or higher polyfunctional (meth)acrylate is used as the polyfunctional monomer (b1). Examples of polyfunctional (meth)acrylates include ethylene glycol di(meth)acrylate, propylene glycol di(meth)acrylate, polyethylene glycol di(meth)acrylate, polypropylene glycol di(meth)acrylate, neopentyl glycol di(meth)acrylate, pentaerythritol di(meth)acrylate, pentaerythritol tri(meth)acrylate, dipentaerythritol hexa(meth)acrylate, 1,6-hexanediol di(meth)acrylate, 1,12-dodecanediol di(meth)acrylate, trimethylolpropane tri(meth)acrylate, tetramethylolmethane tri(meth)acrylate, epoxy acrylate, polyester acrylate, and urethane acrylate. For the polyfunctional (meth)acrylate, solely one species or a combination of two or more species can be used. A polyfunctional (meth)acrylate and another polyfunctional monomer can be used together as well.

For the suitability for formation of the second network suited for realizing a supple and durable resin film, in some embodiments, it is preferable to use a polyfunctional (meth)acrylate having an oxyalkylene unit-repeating structure (a polyoxyalkylene chain), for instance, polyethylene glycol di(meth)acrylate and polypropylene glycol di(meth)acrylate. In particular, a di(meth)acrylate having a polyoxyalkylene chain is preferable. In view of the reactivity, etc., a polyalkylene glycol diacrylate is more preferable. As the polyfunctional (meth)acrylate having a polyoxyalkylene chain, it is preferable to use a species having a weight average molecular weight (Mw) of about 400 to 900.

The number of reactive functional groups (f2) ((meth)acryloyl groups) per molecule of polyfunctional (meth)acrylate is not particularly limited as long as it is 2 or more. For instance, it can be about 2 to 10. From the standpoint of the ease of obtaining a network structure suited for obtaining a supple and durable resin film, in some embodiments, the number of reactive functional groups (f2) per molecule of polyfunctional (meth)acrylate is suitably less than 6.0, preferably less than 4.5, more preferably less than 4.0, possibly less than 3.5, less than 3.0, or less than 2.5.

The number of reactive functional groups (f2) per molecule of polyfunctional (meth)acrylate indicates, in an embodiment using only one species of polyfunctional (meth)acrylate as the polyfunctional monomer, the number of reactive functional groups (f2) in one molecule of the polyfunctional (meth)acrylate. In an embodiment using two or more species of polyfunctional (meth)acrylates differing in number of reactive functional groups (f2) per molecule, it indicates the number determined as the sum of the product of the number of reactive functional groups (f2) in one molecule of each polyfunctional (meth)acrylate and the weight fraction of the polyfunctional (meth)acrylate in the entire polyfunctional (meth)acrylates used.

From the standpoint of inhibiting local excessive densification in the second network, in some embodiments, the polyfunctional monomer (b1) is preferably essentially free of a polyfunctional (meth)acrylate having 4 or more reactive functional groups (f2) per molecule, or more preferably essentially free of a polyfunctional (meth)acrylate having 3 or more reactive functional groups (f2) per molecule.

### (Polyfunctional Isocyanate Compound)

In some embodiment, as the polyfunctional monomer (b1), a bifunctional or higher polyfunctional isocyanate compound can be preferably used. Specific examples of polyfunctional isocyanate compounds are the same as the examples of isocyanate-based crosslinking agents. Thus, the details are not repeated.

The number of reactive functional groups (f2) (isocyanate groups) per molecule of polyfunctional isocyanate compound is not particularly limited as long as it is 2 or more. For instance, it can be about 2 to 10. From the standpoint of the ease of obtaining a network structure suited for obtaining a supple and durable resin film, in some embodiments, the number of reactive functional groups (f2) per molecule of polyfunctional isocyanate compound is suitably less than 6.0, preferably less than 4.5, possibly less than 4.0, or even less than 3.5. For the same reason, in some embodiments, the number of reactive functional groups (f2) per molecule of polyfunctional isocyanate compound can be 2.0 or more, 2.5 or more, or even 3.0 or more.

The number of reactive functional groups (f2) per molecule of polyfunctional isocyanate compound indicates, in an embodiment using only one species of polyfunctional isocyanate compound as the polyfunctional monomer, the number of reactive functional groups (f2) in one molecule of the polyfunctional isocyanate compound. In an embodiment using two or more species of polyfunctional isocyanate compounds differing in number of reactive functional groups (f2) per molecule, it indicates the number determined as the sum of the product of the number of reactive functional groups (f2) in one molecule of each polyfunctional isocyanate compound and the weight fraction of the polyfunctional isocyanate compound in the entire polyfunctional isocyanate compounds used.

From the standpoint of inhibiting local excessive densification in the second network, in some embodiments, the polyfunctional monomer (b1) is preferably essentially free of a polyfunctional isocyanate compound having 3 or more reactive functional groups (f2) per molecule.

(Monofunctional Monomer (b2))

As a monomer used for forming the second network, the second material may include a monofunctional monomer (b2) in addition to the polyfunctional monomer (b1). For instance, the monofunctional monomer (b2) can be used for the purpose of increasing the elongation at break of the resin film, providing flexibility and low-temperature properties, enhancing the tightness of adhesion to adherends, etc. For the monofunctional monomer (b2), solely one species or a combination of two or more species can be used.

As the monofunctional monomer (b2), for instance, it is possible to use a compound having one ethylenically unsaturated group as the reactive functional group (f2) per molecule. Specific examples include the alkyl (meth)acrylates and copolymerizable monomers exemplified as compounds that can be used as starting monomers for preparing the acrylic polymer as the polymer (a1). For instance, in an embodiment using an aforementioned polyfunctional (meth)acrylate as the polyfunctional monomer (b1), it is possible to also use a compound having one ethylenically unsaturated group per molecule as the monofunctional monomer (b2).

The molecular weight of the monofunctional monomer (b2) (when using two or more monofunctional monomers (b2) with different molecular weights, their average molecular weight) is not particularly limited. For instance, it can be about 70 to 3000. In some embodiments, the molecular weight of the monofunctional monomer (b2) is preferably 80 or higher, 100 or higher, or even 120 or higher. In some embodiments, the molecular weight of the monofunctional monomer (b2) is preferably 1000 or lower, more preferably 700 or lower, possibly 500 or lower, 400 or lower, or even 300 or lower.

The amount of the monofunctional monomer (b2) is not particularly limited and can be selected to favorably bring about desirable effects. In some embodiments, of the total amount of the polyfunctional monomer (b1) and the monofunctional monomer (b2) in the second material, the amount of the monofunctional monomer (b2) by weight is suitably less than 70% by weight, preferably less than 50% by weight, possibly less than 40% by weight, or even less than 30% by weight.

### (All Monomers in Second Material)

The possible value and preferable range of the number of functional groups (Σ(Ni×Wi)) in the polyfunctional monomer (b1) can also apply to the average number of functional groups, A, of all the monomers (which include the polyfunctional monomer (b) and may further include the monofunctional monomer (b2)) in the second material. Here, the average number of functional groups A is determined by the next equation:

Average number of functional groups, A=Σ(N′i×W′i)

In this equation, N′i is the number of reactive functional groups (f2) in one molecule of a compound i used as a monomer in the second material, and W′i is the weight fraction of the compound i in all the monomer(s) in the second material. When the monomers in the second material consist of one, two or more species of polyfunctional monomer (b1), Σ(Ni×Wi) equals to Σ(N′I×W′i).

The possible value and preferable range of the average molecular weight (Σ(Mi×Wi)) of the polyfunctional monomer (b1) can also apply to the average molecular weight C of all the monomers in the second material. Here, the average molecular weight C of all the monomers in the second material is determined by the next equation:

Average molecular weight C=Σ(M′i×W′i);

In this equation, M′i is the molecular weight of a compound i used as a monomer in the second material, and W′i is the weight fraction of the compound i in all the monomer(s) in the second material. When the monomers in the second material consist of one, two or more species of polyfunctional monomer (b1), Σ(Mi×Wi) equals to Σ(M′i×W′i).

The possible value and preferable range of the average functional group equivalent (Σ((Mi/Ni)×Wi) of the polyfunctional monomer (b1) can also apply to the average functional group equivalent E of all the monomers in the second material. Here, the average functional group equivalent E of all the monomers in the second material is determined by the next equation:

Functional group equivalent E=Σ((M′i/N′i)×W′i);

In this equation, M′i is the molecular weight of a compound i used as a monomer in the second material, N′i is the number of reactive functional groups (f2) in one molecule of the compound i, and W′i is the weight fraction of the compound i in all the monomers in the second material. When the monomers in the second material consist of one, two or more species of polyfunctional monomer (b1), Σ((Mi/Ni)×Wi) equals to Σ((M′i/N′i)×W′i).

As a component of the second material, when a monofunctional monomer (b2) is used in addition to the polyfunctional monomer (b1), in view of forming the second network suited for realizing a supple and durable resin film, it is preferable to select the species of monofunctional monomer (b2) and its amount so as to satisfy one or more, two or more, or three or more among the average number (A) of functional groups, average molecular weight C and average functional group equivalent E.

The number (B) of parts (by weight) of all the monomers in the second material relative to 100 parts by weight of the polymer (a1) in the first material is not particularly limited and can be suitably set to obtain a supple and durable resin film. The number (B) of parts used is, for instance, possibly 0.1 part by weight or greater, suitably 0.5 part by weight or greater, preferably greater than 1 part by weight, more preferably greater than 3 parts by weight (e.g., 3.5 parts by weight or greater), or also possibly 4 parts by weight or greater. With increasing number (B) of parts used, the durability of the resin film tends to improve in general. In some embodiments, the number (B) of parts used can be greater than 6 parts by weight, greater than 10 parts by weight, greater than 15 parts by weight. The number (B) of parts used is, for instance, possibly less than 50 parts by weight, advantageously less than 40 parts by weight, preferably less than 30 parts by weight, possibly less than 25 parts by weight, or even less than 23 parts by weight. The number (B) of parts used is preferably not too high in view of providing the resin film with suitable suppleness.

In some embodiments, the second material is preferably free of a monomer (especially a polyfunctional monomer) having a bisphenol structure. The lack of use of a monomer having a bisphenol structure allows avoiding an excessively rigid second network and a supple and flexible resin film tends to be readily obtained.

### <Composition Index>

In some preferable embodiments of the resin film disclosed herein, based on the average number (A) of functional groups of all the monomers in the second material, the number (B) of parts (by weight) used per 100 parts by weight of the polymer (a1), the weight average molecular weight C of all the monomers, and the weight average molecular weight D of the polymer (a1) in the first material, the composition index Y1 is preferably 0.20 or higher and 0.85 or lower, determined by the following equation (1):

Y1=[(AB/C)/D]×10⁷ (1)

The equation (1) is preferably applied when the polymer (a1) is a non-polyester-based polymer. It is particularly preferably applied when the polymer (a1) is an acrylic polymer. In the equation (1), as A/C increases, the distances among reactive functional groups (f2) in the second network tend to decrease. As B increases, the weight of the second network per weight of the first network in the resin film will increase. A greater AB/C value means that there are many second networks that are finely meshed. How much influence this second network has on the stretching behavior of the resin film varies depending on the weight average molecular weight D of the polymer (a1) in the first material. As (AB/C)/D increases, the contribution of the second network tends to increase. By setting A, B, C and D to allow the contribution of the second network to be in a suitable range (specifically, to allow the composition index Y1 to be in the range of 0.20 or higher and 0.85 or lower), it is possible to preferably realize a resin film that is supple and durable (e.g., having a stress integral value of greater than 10 MPa).

In the polymer (a1) is a polyester-based polymer, based on the average number (A) of functional groups of all the monomers in the second material, the number (B) of parts (by weight) used per 100 parts by weight of the polymer (a1), the weight average molecular weight C of all the monomers, and the weight average molecular weight D′ of the polymer (a1), the composition index Y2 is preferably 6.0 or higher and 7.0 or lower, determined by the following equation (2):

Y2=[(AB/C)/D]×10⁷ (2)

In an embodiment where the polymer (a1) is a polyester-based polymer, by setting A, B, C and D′ to allow the composition index Y2 to be in the range of 6.0 or higher and 7.0 or lower, it is possible to preferably realize a resin film that is supple and durable (e.g., having a stress integral value of greater than 10 MPa).

### <Other Components>

Described next is the resin film disclosed herein or optional components that are used in the resin composition used for forming the resin film.

### (Photopolymerization Initiator)

In some embodiments, one or both of the first and second materials can be cured by photoirradiation. In such an embodiment, to accelerate curing by photoirradiation, a photopolymerization initiator can be used as necessary. As the photopolymerization initiator, similar to the photopolymerization initiators exemplified as usable species in the synthesis of polymer (a1), it is possible to use ketal-based photopolymerization initiators, acetophenone-based photopolymerization initiators, benzoin ether-based photopolymerization initiators, acylphosphine oxide-based photopolymerization initiators, α-ketol photopolymerization initiators, aromatic sulphonyl chloride-based photopolymerization initiators, photoactive oxime-based photopolymerization initiators, benzoin-based photopolymerization initiators, benzylic photopolymerization initiators, benzophenone-based photopolymerization initiators, thioxanthone-based photopolymerization initiators, etc. For the photopolymerization initiator, solely one species or a combination of two or more species can be used.

Specific examples of ketal-based photopolymerization initiators include 2,2-dimethoxy-1,2-diphenylethane-1-one.

Specific examples of acetophenone-based photopolymerization initiators include 1-hydroxycyclohexyl phenyl ketone, 4-phenoxydichloroacetophenone, 4-t-butyl-dichloroacetophenone, 1-[4-(2-hydroxyethoxy)-phenyl]-2-hydroxy-2-methyl-1-propane-1-one, 2-hydroxy-2-methyl-1-phenyl-propane-1-one and methoxyacetophenone

Specific examples of benzoin ether-based photopolymerization initiators include benzoin ethers such as benzoin methyl ether, benzoin ethyl ether, benzoin propyl ether, benzoin isopropyl ether and benzoin isobutyl ether as well as substituted benzoin ethers such as anisole methyl ether.

Specific examples of acylphosphine oxide-based photopolymerization initiators include bis(2,4,6-trimethylbenzoyl)phenylphosphine oxide, bis(2,4,6-trimethylbenzoyl)-2,4-di-n-butoxyphenylphosphine oxide, 2,4,6-trimethylbenzoyldiphenylphosphine oxide and bis(2,6-dimethoxybenzoyl)-2,4,4-trimethylpentylphosphine oxide.

Specific examples of α-ketol-based photopolymerization initiators include 2-methyl-2-hydroxypropiophenone and 1-[4-(2-hydroxyethyl)phenyl]-2-methylpropane-1-one. Specific examples of aromatic sulfonyl chloride-based photopolymerization initiators include 2-naphthalenesulfonyl chloride. Specific examples of photoactive oxime-based photopolymerization initiators include 1-phenyl-1,1-propanedione-2-(o-ethoxycarbonyl)-oxime. Specific examples of benzoin-based photopolymerization initiators include benzoin. Specific examples of benzil-based photopolymerization initiators include benzil.

Specific examples of benzophenone-based photopolymerization initiators include benzophenone, benzoylbenzoic acid, 3,3′-dimethyl-4-methoxybenzophenone, polyvinylbenzophenone and α-hydroxycyclohexylphenylketone.

Specific examples of thioxanthone-based photopolymerization initiators include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone and 2,4-diisopropylthioxanthone, dodecylthioxanthone.

The amount of photopolymerization initiator is not particularly limited and can be selected to suitably obtain desirable effects. In some embodiments, the photopolymerization initiator content per 100 parts by weight of the material (first or second material) to be cured can be, but is not limited to, for instance, about 0.02 part by weight to 2 parts by weight.

### (Crosslinking Catalyst)

In an embodiment using a crosslinking catalyst for curing the first material, to allow the crosslinking reaction to proceed effectively, a crosslinking catalyst may be used. The crosslinking catalyst can be, an organometallic complex (chelate), a compound formed of a metal and an alkoxy group, a compound formed of a metal and an acyloxy group, a tertiary amine, etc. In particular, organometallic compounds are preferable from the standpoint of suppressing the progress of the crosslinking reaction as a solution at room temperature and ensuring a pot life for the resin composition used for forming the resin film disclosed herein. An organometallic compound that is liquid at room temperature is preferable as the crosslinking catalyst because it facilitates the introduction of a crosslinking structure that is uniform in the thickness direction of the resin film.

Examples of metals in organometallic compounds include iron, tin, aluminum, zirconium, zinc, titanium, lead, cobalt, and zinc. Examples include iron-based crosslinking accelerators such as tris(acetylacetonato) iron, tris(hexane-2,4-dionato) iron, and tris(heptane-2,4-dionato) iron; tin-based crosslinking accelerators such as dibutyltin dichloride, dibutyltin oxide, and dibutyltin dibromide; aluminum-based crosslinking accelerators such as aluminum diisopropylate mono-sec-butylate, aluminum sec-butylate, aluminum isopropylate, tris(acetylacetonato) aluminum, aluminum tris(theylacetoacetato), and diisopropoxyaluminum ethyl acetoacetate; zirconium-based crosslinking accelerators such as zirconium acetylacetonate, zirconium acetylacetonate, and zirconium tributoxy-mono-acetonate; zinc-based crosslinking accelerators such as zinc naphthenate and zinc 2-ethylhexanoate; titanium-based crosslinking accelerators such as dibutyltitanium dichloride, tetrabutyl titanate, and tetraisopropyl titanate; lead-based crosslinking accelerators such as lead oleate, lead 2-ethylhexanoate, and lead benzoate; and cobalt-based crosslinking accelerators such as cobalt 2-ethylhexanoate and cobalt benzoate.

The amount of crosslinking accelerator can be suitably adjusted in accordance with the species and amount of crosslinking agent as well as the species of crosslinking accelerator. The amount of crosslinking accelerator used per 100 parts by weight of the polymer (a1) is generally about 0.001 part to 2 parts by weight. When using a crosslinking accelerator for an isocyanate-based crosslinking agent, the amount of the crosslinking accelerator is preferably about 0.001 part to 0.1 part by weight per 100 parts by weight of the polymer (a1). When using a crosslinking accelerator for an epoxy-based crosslinking agent, the amount of the crosslinking accelerator is preferably about 0.01 part to 2.0 parts by weight per 100 parts by weight of the polymer (a1). For epoxy-based crosslinking agents, it is preferable to use non-tin-based organometals as crosslinking accelerators.

### (Crosslinking Retarder)

The resin composition used for forming the resin film disclosed herein may include a keto-enol tautomeric compound as a crosslinking retarder as desired. A preferable example is a compound that shows keto-enol tautomerism in the resin composition comprising an isocyanate-based crosslinking agent (polyfunctional isocyanate compound). This can be effective in extending the PSA composition's pot life.

As the keto-enol tautomeric compound, various β-dicarbonyl compounds can be used. Specific examples include $-diketones such as acetylacetone and 2,4-hexanedione; acetoacetates such as methyl acetoacetate and ethyl acetoacetate; propionylacetates such as ethyl propionylacetate; isobutyrylacetates such as ethyl isobutyrylacetate; and malonates such as methyl malonate and ethyl malonate. Particularly favorable compounds include acetylacetone and acetoacetates. For the keto-enol tautomeric compound, solely one species or a combination of two or more species can be used.

The amount of the keto-enol tautomeric compound used to 100 parts by weight of polymer (a1) can be, for instance, 50 parts by weight or less, preferably 35 parts by weight or less, or more preferably 25 parts by weight or less; and, for instance, 0.1 part by weight or greater, preferably 0.5 part by weight or greater, or more preferably 1 part by weight or greater.

### (Other Optional Components)

The resin film disclosed herein or the resin composition used for forming the resin film may include, as necessary, various additives generally used in the field of PSA or resin film for PSA sheet as other optional components, such as a tackifier resin (e.g. rosin-based, petroleum-based, terpene-based, phenolic and ketone-based tackifier resins, etc.), viscosity-adjusting agent (e.g. thickener), leveling agent, plasticizer, filler, colorant including pigment and dye, etc., stabilizing agent, preservative, anti-aging agent, antistatic agent, filler, slip agent, anti-blocking agent and so on. With respect to these various additives, those heretofore known can be used according to typical methods. Since these do not particularly characterize the present invention, details are omitted.

### <Preparation of Resin Film>

The form of the resin composition used for forming the resin film disclosed herein is not particularly limited. It can be in various forms, for instance, a solvent-based resin composition comprising resin film components in an organic solvent; a water-dispersed resin composition as a water dispersion of resin film components; a photocurable resin composition that transitions from liquid to viscoelastic material when cured by irradiation with light (e.g., UV); and the like. From the standpoint of the ease of preparing the resin composition, ease of forming the resin film, etc., in some embodiments, a solvent-based resin composition can be preferably used.

The resin film can be formed from the resin composition using, for instance, a gravure roll coater, reverse roll coater, kiss roll coater, dip roll coater, bar coater, knife coater, spray coater, die coater, etc. Alternatively, the resin film can be formed by means such as extrusion, inflation molding, T-die casting, and calender rolling.

The resin film thickness is not particularly limited. It can be, for instance, about 3 μm to 500 μm. When the resin film is used as a PSA layer (adhesive resin film) constituting a PSA sheet, from the standpoint of effectively bringing about the advantages of having supple and durable properties, the PSA layer thickness is suitably 5 μm or greater, preferably 10 μm or greater, or more preferably 15 μm or greater (e.g., 20 μm or greater). In some embodiments, the PSA layer thickness can be, for instance, 200 μm or less, 150 μm or less, 100 μm or less, 70 μm or less, 50 μm or less, or even 35 μm or less. For instance, in an embodiment having a PSA layer with a thickness of about 15 μm to 70 μm, the effect of having the resin film disclosed herein as the PSA layer can be favorably obtained.

### <Structural Examples of PSA Sheet>

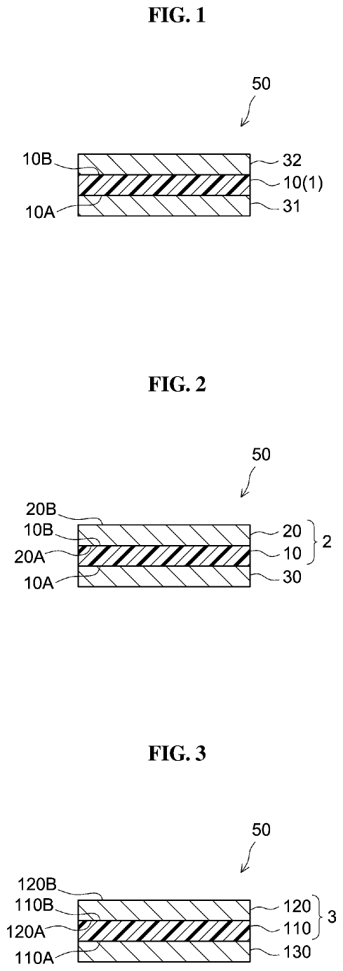

FIG. 1 shows a structural example of the PSA sheet comprising the resin film disclosed herein as the PSA layer. PSA sheet 1 is a double-faced PSA sheet without substrate formed of adhesive resin film (PSA layer) 10. For instance, as shown in FIG. 1, PSA sheet 1 before used (before applied to an adherend) may be in the form of a release-linered PSA sheet 50 with the respective faces 10A and 10B of a PSA layer 10 are protected with release liners 31 and 32 each having a release surface (release face) at least on the PSA layer side. Alternatively, it may have a form with a release liner 31 having a release face on the backside (the surface opposite to the PSA side); and when wound or layered to bring adhesive face 10B in contact with the backside of release liner 31, adhesive faces 10A and 10B are protected.

The release liner is not particularly limited. It is possible to use, for instance, a release liner having a release-treated surface on a liner substrate such as plastic film or paper; or a release liner formed from a low-adhesive material such as a fluoropolymer (polytetrafluoroethylene, etc.) or a polyolefinic resin (polyethylene, polypropylene, etc.). In the release treatment, it is possible to use, for instance, a release agent that is silicone-based, long-chain alkyl-based, etc. In some embodiments, a release-treated resin film can be preferably used as the release liner.

FIG. 2 shows another structural example of the PSA sheet comprising the resin film disclosed herein as the PSA layer. PSA sheet 2 is constituted as a single-faced PSA sheet with substrate, that is, an adhesively single-faced PSA sheet that includes a PSA layer (adhesive resin film) 10 having one surface 10A as an adhesive face applied to an adherend as well as a substrate (support) 20 layered on the other surface 10B of PSA layer 10. PSA layer 10 is joined to one surface 20A of a substrate 20. As substrate 20, a resin film such as polyester film can be used. For instance, as shown in FIG. 2, PSA sheet 2 before used (before applied to an adherend) may be in the form of a release-linered PSA sheet 50 with the adhesive face 10A protected with a release liner 30 having a releasable surface (release face) at least on the PSA layer side. Alternatively, it may have a form with substrate 20 whose second face 20B (the surface opposite to the first face 20A, also called the backside) is a release face; and when wound or layered to bring adhesive face 10A in contact with the second face 20B of substrate 20, adhesive face 10A is protected.

FIG. 3 shows a structural example of the PSA sheet comprising the resin film disclosed herein as the substrate film. PSA sheet 3 is constituted as a single-faced PSA sheet with substrate, that is, an adhesively single-faced PSA sheet that includes a PSA layer 110 having one surface 110A as an adhesive face applied to an adherend as well as a substrate film (non-adhesive or weakly-adhesive resin film) 120 layered on the other surface 10B of PSA layer 110. PSA layer 110 is joined to one surface 120A of a substrate 120. For instance, as shown in FIG. 3, PSA sheet 3 before used (before applied to an adherend) may be in the form of a release-linered PSA sheet 50 with the adhesive face 110A protected with a release liner 130 having a releasable surface (release face) at least on the PSA layer side. Alternatively, it may have a form with substrate 120 whose second face (backside) 120B is a release face; and when wound or layered to bring adhesive face 110A in contact with the second face 120B of substrate 120, adhesive face 110A is protected.

The PSA sheet including the resin film disclosed herein can also be in the form of a double-faced PSA sheet with substrate, in which the first PSA layer is laminated on one surface of a substrate sheet and the second PSA layer is laminated on the other surface of the substrate. In the PSA sheet of such a form, among the first and second PSA layers and the substrate, any one, two or more can be formed of a resin film disclosed herein.

<PSA Sheet with Substrate>

When using the resin film disclosed herein as a PSA layer that constitutes a PSA sheet with substrate (including a single-faced PSA sheet with substrate and a double-faced PSA sheet with substrate; hereinafter, the same applies unless otherwise noted), the material of the substrate in the PSA sheet with substrate is not particularly limited and can be suitably selected in accordance with the purpose and application of the PSA sheet. Non-limiting examples of the substrate that may be used include plastic films including a polyolefin film whose primary component is a polyolefin such as polypropylene and ethylene-propylene copolymer, a polyester film whose primary component is polyester such as polyethylene terephthalate and polybutylene terephthalate, and a polyvinyl chloride film whose primary component is polyvinyl chloride; a foam sheet formed of a foam such as polyurethane foam, polyethylene foam and polychloroprene foam; woven and nonwoven fabrics of single or blended spinning of various fibrous materials (which may be natural fibers such as hemp and cotton, synthetic fibers such as polyester and vinylon, semi-synthetic fibers such as acetate, etc.); paper such as Japanese paper, high-quality paper, kraft paper and crepe paper; and metal foil such as aluminum foil and copper foil. The substrate may be formed of a composite of these materials. Examples of such composite substrates include a substrate having a layered structure with a metal layer (e.g., metal foil, continuous or non-continuous metal spatter layer, vapor-deposited metal layer, metal plating layer, etc.) or a metal oxide layer and the plastic film as well as a plastic film reinforced with inorganic fibers such as glass cloth.

When using the resin film disclosed herein as a substrate (substrate film) that constitutes a PSA sheet with substrate, the type of PSA constituting the PSA layer in the PSA sheet with substrate is not particularly limited and can be suitably selected in accordance with the purpose and application of the PSA sheet. For example, the PSA layer may be constituted, comprising one, two or more species of PSA selected among various known species of PSA, such as an acrylic PSA, rubber-based PSA (natural rubber-based, synthetic rubber-based, their mixture-based, etc.), silicone-based PSA, polyester-based PSA, urethane-based PSA, polyether-based PSA, polyamide-based PSA, fluorine-based PSA, etc. As for the PSA layer, no particular limitations are imposed on the properties such as the stress integral value, hysteresis, and the ratio of stress integration area. For instance, the PSA layer can be a resin film (adhesive resin film) that satisfies the abovementioned stress integral value, or a layer whose stress integral value is 10 MPa or less (e.g., 9 MPa or less).

In the PSA sheet with substrate comprising the resin film disclosed herein as the PSA layer or the substrate (substrate film), the substrate thickness is not particularly limited and can be suitably selected in accordance with the purpose and application of the PSA sheet. The substrate thickness can be, for instance, 1000 μm or less, 500 μm or less, 100 μm or less, 70 μm or less, 50 μm or less, 25 μm or less, 10 μm or less, or even 5 μm or less. With decreasing substrate thickness, the PSA sheet's flexibility and conformability to surface structures of adherends tend to improve. From the standpoint of the ease of handling, processing and so on, the substrate thickness can be, for instance, 2 μm or greater, 4 μm or greater, 7 μm or greater, or even 10 μm or greater.

Of the substrate, the face on the side to be bonded to the PSA layer may be subjected as necessary to a heretofore known surface treatment such as corona discharge treatment, plasma treatment, UV irradiation, acid treatment, alkali treatment, primer coating, and antistatic treatment. These surface treatments may increase the tightness of adhesion between the substrate and the PSA layer, that is, the anchoring of the PSA layer to the substrate. The composition of the primer is not particularly limited and can be suitably selected among known species. While the thickness of the primer layer is not particularly limited, it is suitably about 0.01 μm to 1 μm, or preferably about 0.1 μm to 1 μm.

In the single-faced PSA sheet with substrate, as necessary, the backside (the surface opposite to the side joined to a PSA layer) of the substrate may be subjected to heretofore known surface treatments such as release treatment, treatment to increase adhesive or pressure-sensitive adhesive properties, and antistatic treatment. For instance, the substrate backside can be surface-treated with a release agent to reduce the unwinding force of the PSA sheet wound in a roll. Possible release agents include a silicone-based release agent, long-chain alkyl-based release agent, olefinic release agent, fluorine-based release agent, aliphatic acid amide-based release agent, molybdenum disulfide, and silica powder.

### <Applications>

As described above, the resin film provided by this description can be preferably used as a PSA sheet or its constituent (substrate film, etc.), taking advantage of the features of suppleness and durability.

For instance, the resin film according to some embodiments has a large stress integral value. Thus, when used as the PSA layer constituting the adhesive surface of the PSA sheet, in the thread formation that occurs at the interface for peel from the adherend, the resulting threads can be supple and durable. Thus, it is suited for combining high peel strength with good anti-adhesive-residue properties.

Having a network structure (double network structure) in which the first and second networks coexist in the same layer and are physically interlaced with each other through net holes, the resin film according to some embodiments has an excellent ability to disperse stress against external force. This is advantageous in increasing the impact resistance of the PSA sheet.

Even when the PSA layer is designed to be relatively hard (e.g., to have a storage modulus of 1 MPa or greater, or even 5 MPa or greater at 25° C.) in accordance with the application of the PSA sheet, such excellent stress dispersion inhibits the PSA layer from becoming brittle due to the design. Thus, when processing the PSA sheet having a hard PSA layer as described above, it may be unlikely to cause a defect (PSA-lacking spot) to the PSA layer. The PSA layer's maximum storage modulus at 25° C. is not particularly limited and can be, for instance, 10 MPa or less. The PSA layer's maximum storage modulus at 25° C. is determined as follows: Several layers of the PSA sheet or PSA layer subject to analysis are layered to fabricate an approximately 2 mm thick PSA layer. Of the resulting PSA layer, a 7.9 mm diameter disc is punched out of an approximately 1.5 mm thick sheet formed of the PSA layer of interest (prepared by laminating several layers of the PSA layer as necessary) to prepare a measurement specimen. The measurement specimen is placed between parallel plates. While applying shear strain at a frequency of 1 Hz using a rheometer (e.g., ARES available from TA Instruments or a comparable product), mechanical viscoelastic analysis is carried out in shear mode at a heating rate of 5° C./min over a temperature range of 70° C. to 150° C. to determine the storage modulus at 25° C.

The resin film according to some embodiments is characterized by having at least a certain hysteresis value. The resin film with such a large hysteresis value can be preferably used, for instance, as a substrate in a PSA sheet that is applied to an adherend having a movable part (e.g., human joint, foldable display, etc.). The resin film shows such properties that the stress required to stretch it to the same length in the second and subsequent stretching cycles is greatly reduced in comparison with the first stretching cycle. After the PSA sheet is applied, if the movable part is allowed to undergo first deformation to stretch the resin film where it covers the movable part, the second and subsequent deformations are less restricted by the PSA sheet. For instance, in an application where it is applied over a human joint, because of the hysteresis, the movement of the movable part is less likely to be hindered in the second and subsequent deformations, and the unstretched area (applied to the surrounding area of the movable part) can show reinforcing effects by taking advantage of the initial strength.

As understood from the above description and undermentioned Examples, the subject matter disclosed by this description includes the following:
(1) A resin film that has a stress integral value of greater than 10 MPa and 1000 MPa or less when uniaxially stretched at a tensile speed of 300 mm/min at 25° C. until it breaks.
(2) The resin film according to (1) above, that has an elongation at break of 100% or higher and 5000% or lower (preferably 300% or higher and 4500% or lower) when uniaxially stretched at a tensile speed of 300 mm/min at 25° C. until it breaks.
(3) The resin film according to (1) above, that has a hysteresis of 1.2 or higher and 20 or lower (preferably above 1.2 and 20 or lower) at 25° C., obtained by the following test:
[Test Method]
   (I) samples A and B are obtained for breaking elongation measurement and hysteresis measurement, respectively;
   (II) at 25° C., the sample A is uniaxially stretched at a tensile speed of 300 mm/min until it breaks to determine the elongation at break, X (%);
   (III) at 25° C., the sample B is subjected to the first stretching cycle where it is uniaxially stretched at a tensile speed of 300 mm/min to 0.7X (%) from the initial chuck distance and held for 1 second at the end of the stretching; and then pulled back at a pulling-back speed of 300 mm/min to the initial chuck distance of 10 mm and held for 10 seconds; and subsequently, the sample B is subjected to the second stretching cycle where it is uniaxially stretched to 0.8X (%) from the initial chuck distance and held for 1 second at the end of the stretching; and then pulled back at a pulling-back speed of 300 mm/min to the initial chuck distance and held for 10 seconds; and
   (IV) from the stress S1 (MPa) required to stretch the sample B to (0.7X−40) % elongation in the first cycle of stretching and the stress S2 (MPa) required to stretch the sample B to (0.7X−40) % elongation, S1/S2 is determined and this value is used as the hysteresis.
(4) The resin film according to (1) above, that shows necking behavior that results in a ratio (Wₘᵢₙ/Wₘₐₓ) of higher than 0 and 0.90 or lower at 25° C. based on the following necking test:

### [Necking Test]

(I) samples A and C are obtained for breaking elongation measurement and necking measurement, respectively;
(II) at 25° C., the sample A is uniaxially stretched at a tensile speed of 300 mm/min until it breaks to determine the elongation at break, X (%);
(III) at 25° C., the sample C is uniaxially stretched at a tensile speed of 300 mm/min from the initial chuck distance to 0.5X (%); at the end of the stretching, within 1 second after the end of stretching, a photograph of the stretched sample is taken with a digital camera, wherein the photograph is taken from a direction perpendicular to the stretching direction of the sample; and
(IV) with respect to the middle 60% range excluding 20% from each end of the stretched sample, the sample's minimum width Wₘᵢₙ and maximum width Wₘₐₓ are measured in number of pixels to calculate their ratio (Wₘᵢₙ/Wₘₐₓ).
(5) A resin film that satisfies at least one (preferably two or more, more preferably three of more) among the following conditions (i) to (iv):
   (i) having a stress integral value of greater than 10 MPa and 1000 MPa or less when uniaxially stretched at a tensile speed of 300 mm/min at 25° C. until it breaks;
   (ii) having an elongation at break of 100% or higher and 5000% or lower (preferably 300% or higher and 4500% or lower, e.g., 300% or higher and 2400% or lower) when uniaxially stretched at a tensile speed of 300 mm/min at 25° C. until it breaks;
   (iii) having a hysteresis of 1.2 or higher and 20 or lower (preferably above 1.2 and 20 or lower, e.g., above 1.4 and 20 or lower) at 25° C., obtained by the test according to (3) above; and
   (iv) showing necking behavior that results in a ratio (Wₘᵢₙ/Wₘₐₓ) of higher than 0 and 0.90 or lower at 25° C. based on the necking test according to (4) above.
(6) The resin film according to any of (1) to (5) above, wherein the resin film comprises first and second networks coexisting in the same layer, and the first and second networks are physically interlaced with each other through net holes.
(7) The resin film according to (6) above, wherein the first network is a cured product of a first material, with the first material comprising a polymer (a1) having reactive functional groups (f1); and the second network is a cured product of a second material, with the second material comprising a polyfunctional monomer (b1) having two or more reactive functional groups (f2) in one molecule.
(8) The resin film according to (7) above, wherein the polymer (a1) is an acrylic polymer.
(9) The resin film according to (8) above, wherein the polymer (a1) has a weight average molecular weight of 80×10⁴ or higher.
(10) The resin film according to (7) or (8) above, having a composition index Y1 of 0.20 or higher and 0.85 or lower, determined as follows: based on the average number (A) of functional groups of all the monomers in the second material, the number (B) of parts (by weight) of all the monomers used per 100 parts by weight of the polymer (a1), the average molecular weight C of all the monomers, and the weight average molecular weight D of the polymer (a1), the composition index Y1 is determined by the following equation (1):

Y1=[(AB/C)/D]×10⁷ (1)
(11) The resin film according to (6) above, wherein the polymer (a1) is a polyester-based polymer.
(12) The resin film according to (11) above, having a composition index Y2 of 6.0 or higher and 7.0 or lower, determined as follows: based on the average number (A) of functional groups of all the monomers in the second material, the number (B) of parts (by weight) of all the monomers used per 100 parts by weight of the polymer (a1), the weight average molecular weight C of all the monomers, and the number average molecular weight D′ of the polymer (a1), the composition index Y2 is determined by the following equation (2):

Y2=[(AB/C)/D′]×10⁷ (2)
(13) A PSA sheet comprising the resin film according to any of (1) to (12) above.
(14) A resin composition, that is used for forming the resin film according to any of (1) to (12) above.

### EXAMPLES

Several working examples related to the present invention are described below, but the specific examples are not to limit the present invention. In the description below, “parts” and “%” indicating amounts used or added are by weight unless otherwise specified.

### <Synthesis of Acrylic Polymers>

### (Acrylic Polymer P1)

Into a reaction vessel equipped with a condenser, nitrogen inlet, thermometer and stirrer, was placed a mixture of 100 parts of ethyl acetate, 95 parts of butyl acrylate (BA) and 5 parts of acrylic acid (AA). The air inside was purged with nitrogen. In absence of oxygen, the temperature inside was raised to 65° C. Subsequently, was added the entire amount of a solution obtained by dissolving 0.3 part of azobisisobutyronitrile (AIBN) in 10 parts of ethyl acetate. The temperature inside was then maintained at 65° C. for 6 hours and the polymerization was completed to obtain a solution of acrylic polymer P1. The weight average molecular weight (GPC, based on standard polystyrene) was 100×10⁴.

### (Acrylic Polymer P2)

Into a reaction vessel equipped with a condenser, nitrogen inlet, thermometer and stirrer, was placed a mixture of 100 parts of ethyl acetate, 95 parts of BA and 5 parts of AA. The air inside was purged with nitrogen. In absence of oxygen, the temperature inside was raised to 70° C. Subsequently, was added the entire amount of a solution obtained by dissolving 0.03 part of AIBN in 10 parts of ethyl acetate. The temperature inside was then maintained at 69° C. to 71° C. for 6 hours and the polymerization was completed to obtain a solution of acrylic polymer P2. The weight average molecular weight (GPC, based on standard polystyrene) was 160×10⁴.

### (Acrylic Polymer P3)

Into a reaction vessel equipped with a condenser, nitrogen inlet, thermometer and stirrer, was placed a mixture of 100 parts of ethyl acetate, 95 parts of methyl acrylate (MA) and 5 parts of AA. The air inside was purged with nitrogen. In absence of oxygen, the temperature inside was raised to 70° C. Subsequently, was added the entire amount of a solution obtained by dissolving 0.3 part of AIBN in 10 parts of ethyl acetate. The temperature inside was then maintained at 69° C. to 71° C. for 6 hours and the polymerization was completed to obtain a solution of acrylic polymer P3. The weight average molecular weight (GPC, based on standard polystyrene) was 100×10⁴.

### Preparation of Resin Films

### Example 1

To the acrylic polymer P1 solution, for every 100 parts of acrylic polymer P1 in the solution, were added, 0.03 part of an epoxy-based crosslinking agent (product name TETRAD-C available from Mitsubishi Gas Chemical Company, Inc.), 21 parts of polypropylene glycol #400 diacrylate (product name APG-400 available from Shin-Nakamura Chemical Co., Ltd., Mw 536, bifunctional) as a polyfunctional monomer and 0.4 part of a photoinitiator (product name OMNIRAD 651 available from IGM Resins). This was uniformly mixed to prepare a resin composition.

To a release face of a 38 μm thick polyethylene terephthalate (PET) film (product name MRF38 available from Mitsubishi Chemical Corporation, Inc.; or “release liner R” hereinafter) that had been silicone-treated (release treatment), was applied the resin composition to a dry thickness of 25 μm and allowed to dry at 120° C. for 2 minutes. This was adhered to a release face of a 38 μm thick PET film (product name MRF38 available from Mitsubishi Chemical Corporation, Inc.; or “release liner R2” hereinafter) that had been silicone-treated (release treatment) and allowed to age at 40° C. for 3 days. Subsequently, using a UV irradiator (UM-810 available from Nitto Seiki Co., Ltd.), the resultant was exposed to a UV dose of 3000 mJ/cm². In this manner, was obtained a laminate comprising the resin film (PSA layer) according to this Example. The laminate has a layered structure formed of release film R1/PSA layer (PSA sheet without substrate)/release film R2 (the same is true in Examples 2 to 7 and 9 to 12).

### Example 2

The amount and the species of polyfunctional monomer were changed to 22 parts of polypropylene glycol #700 diacrylate (product name APG-700 available from Shin-Nakamura Chemical Co., Ltd., Mw 796, bifunctional). Otherwise in the same manner as Example 1, were prepared a resin composition and a resin film, and was obtained a laminate comprising the resin film (PSA layer).

### Example 3

The acrylic polymer P1 solution was changed to the acrylic polymer P2 solution. The amount of APG-700 used per 100 parts of acrylic polymer was changed from 22 parts to 16 parts. Otherwise in the same manner as Example 2, were prepared a resin composition and a resin film, and was obtained a laminate comprising the resin film (PSA layer).

### Example 4

15 parts of APG-700 was used and 5 parts of 2-methoxyethyl acrylate (MEA, Mw 130, monofunctional) was further added. Otherwise in the same manner as Example 2, were prepared a resin composition and a resin film, and was obtained a laminate comprising the resin film (PSA layer). In the resin composition, the total number (B) of parts of all monomers (i.e., APG-700 and MEA) in the second material is 20 parts; the average number (A) of functional groups is 1.75; the average molecular weight C is 630; and the average functional group equivalent is 331.

### Example 5

To the acrylic polymer P1 solution, for every 100 parts of acrylic polymer P1 in the solution, were added, 0.03 part of TETRAD-C and 10 parts of a polyisocyanate compound (product name CORONATE L available from Tosoh Corporation, Mw 672, trifunctional) as a polyfunctional monomer. This was uniformly mixed to prepare a resin composition.

To a release face of release liner R1, was applied the resin composition to a dry thickness of 25 μm and allowed to dry at 80° C. for 5 minutes. This was adhered to a release face of release liner R2 and allowed to age at 40° C. for 3 days to obtain a laminate comprising the resin film (PSA layer) according to this Example.

### Example 6

The acrylic polymer P1 solution was changed to the acrylic polymer P2 solution. Otherwise in the same manner as Example 5, were prepared a resin composition and a resin film, and was obtained a laminate comprising the resin film (PSA layer).

### Example 7

The amount of CORONATE L was changed from 10 parts to 8 parts. Otherwise in the same manner as Example 6, were prepared a resin composition and a resin film, and was obtained a laminate comprising the resin film (PSA layer).

### Example 8

To the acrylic polymer P3 solution, for every 100 parts of acrylic polymer P3 in the solution, were added, 0.03 part of TETRAD C and 10 parts of CORONATE L. This was uniformly mixed to prepare a resin composition.

To one face of release liner R1, was applied the resin composition to a dry thickness of 10 μm and allowed to dry at 80° C. for 5 minutes. Then, to this face, was adhered the PSA layer of Example 9 exposed by removal of release film R2 from the laminate prepared in Example 9 described below. Subsequently, the resultant was stored at 25° C. for 72 hours to obtain a laminate comprising a single-faced PSA sheet with substrate formed of the resin film (substrate film) prepared from the resin composition and the PSA layer of Example 9. The laminate has a layered structure formed of release film R1/substrate film/PSA layer/release film R1.

### Example 9

The amount of APG-400 was changed from 21 parts to 5 parts. Otherwise in the same manner as Example 1, were prepared a resin composition and a resin film, and was obtained a laminate comprising the resin film (PSA layer).

### Example 10

The amount of APG-400 was changed from 21 parts to 30 parts. Otherwise in the same manner as Example 1, were prepared a resin composition and a resin film, and was obtained a laminate comprising the resin film (PSA layer).

### Example 11

To an ethyl acetate solution of a polyester resin (product name VYLON BX-1001 Toyobo Co., Ltd., Mn 28000; or polyester-based polymer P4, hereinafter), for every 100 parts of non-volatiles in the solution, were added 0.066 part of zirconium(IV) acetylacetonate (product name ORGATIX ZC-162) as a crosslinking catalyst, 4 parts of CORONATE L as a polyfunctional monomer and 20 parts of acetylacetone as a crosslinking retarder. This was uniformly mixed to prepare a resin composition.

To a release face of release liner R1, was applied the resin composition to a dry thickness of 25 μm and allowed to dry at 150° C. for 1 minute. This was adhered to a release face of release liner R2 and allowed to age at 40° C. for 3 days to obtain a laminate comprising the resin film (PSA layer) according to this Example.

### Example 12

The amount of CORONATE L was changed from 4 parts to 3 parts. Otherwise in the same manner as Example 11, were prepared a resin composition and a resin film, and was obtained a laminate comprising the resin film (PSA layer).

### <Measurements and Evaluations>

### (Stress Integral Value)

From the laminate obtained in each Example, was cut out a 300 mm long and 100 mm wide rectangle. The release film on one side was then removed to expose the PSA layer surface. Atop the release film on the other side, the PSA layer (single-faced PSA sheet with substrate in Example 8) was wound up on the lengthwise axis to prepare a cylindrical sample measuring 30 mm in length and about 1 mm in diameter and weighing about 0.1 g (in Example 8, the sample at large measuring about 2 mm in diameter and weighing about 0.07 g). The upper and lower 10 mm segments of the sample were fixed with chuck jigs of a tensile testing machine (EZ-S 500N available from Shimadzu Corporation). In an environment at 25° C., at a chuck distance of 10 mm and a tensile speed of 300 mm/min, while stretching the sample until it broke, stress values were obtained every 2.5% elongation from the initial length (10 mm). From the resulting stress (MPa) vs. elongation (%) curve, the stress values at the respective elongations were totaled and the sum was multiplied by 2.5 and divided by 100 to obtain the stress integral value (MPa). In Tables 1 and 2, the resulting stress integral value is shown along with the breaking elongation X (%) of each sample.

### (Hysteresis)

A cylindrical sample was prepared in the same manner as the evaluation of the stress integral value and fixed with chuck jigs (chuck distance set to 10 mm) of a tensile testing machine (EZ-S 500N available from Shimadzu Corporation) in the same way. Subsequently, based on the breaking elongation X (%) obtained in the evaluation of the stress integral value, a cycle test was carried out as follows: the sample was first uniaxially stretched to 0.7X (%) (first stretching cycle) and held for 1 second at the end of stretching; then pulled back to the chuck distance of 10 mm and held for 10 seconds; then uniaxially stretched to 0.8X (%) (second stretching cycle) and held for 1 second at the end of stretching; and then pulled back to the chuck distance of 10 mm. The test environment was at 25° C. The stretching and pulling-back speeds were both at 300 mm/min. From stress S1 required to stretch the sample to 0.7X (%)−40% elongation in the first cycle of stretching and stress (S2) required to stretch the sample to 0.7X (%)−40% elongation in the second cycle of stretching, the ratio of stress S1 to stress S2 (i.e., S1/S2) was determined and this value was used as the hysteresis. The results are shown in Tables 1 and 2.

### (Necking)

A cylindrical sample was prepared in the same manner as the evaluation of the stress integral value and fixed with chuck jigs (chuck distance set to 10 mm) of a tensile testing machine (EZ-S 500N available from Shimadzu Corporation) in the same way. In an environment at 25° C., at a chuck distance of 10 mm and a tensile speed of 300 mm/min, based on the breaking elongation X (%) obtained in the evaluation of the stress integral value, the sample was uniaxially stretched to 0.5X (%) from the initial chuck distance. It was judged as follows: when this caused non-uniform lengthwise narrowing of the sample, necking was present; when this caused uniform lengthwise narrowing of the sample, necking was absent. Specifically, at the end of stretching to 0.5X (%), within 1 second after the end of stretching, a photograph of the stretched sample was taken with a digital camera. The photograph was taken from a direction perpendicular to the stretching direction of the sample. In the resulting image data, with respect to the middle 60% range excluding 20% from each end (i.e., the chuck side) of the stretched sample, the sample's minimum width Wₘᵢₙ and maximum width Wₘₐₓ were measured in number of pixels in the image. It was judged as follows: when their ratio (Wₘᵢₙ/Wₘₐₓ) was higher than 0 and 0.90 or lower, necking was present; when higher than 0.90, necking was absent. The results are shown in Tables 1 and 2.

### (Impact Resistance)

The PSA sheets of Examples 1 and 9 were further subjected to the following impact resistance test:

Each PSA sheet was cut into a 1.0 mm wide window frame (picture frame) shape measuring 59 mm horizontally and 113 mm vertically to obtain a double-faced PSA sheet frame. Using the double-faced PSA sheet frame, a first PC plate (polycarbonate plate measuring 70 mm horizontally, 130 mm vertically, 2 mm thick) and a second PC plate (measuring 59 mm horizontally, 113 mm vertically, 0.55 mm thick) were press-bonded together under a load of 5 kg applied for 10 seconds to obtain a test sample.

A 160 g weight was attached to the backside (the surface opposite to the face attached to the second PC plate) of the test sample. The test sample with the weight was subjected to a drop test at room temperature (about 23° C.) where it was allowed to freely fall from a height of 1.2 m onto a concrete board 60 times. Here, the falling direction was adjusted so that the six faces of the test sample took turn to be on the bottom. In other words, for each of the six faces, 10 cycles of one fall pattern were carried out. After each fall, it was visually checked whether the bonding between the first and second PC plates was retained. The number of falls until the first and second PC plates peeled off (separated) was graded as drop-impact resistance at room temperature.

As a result, while no peeling was observed even after 60 falls in Example 1, in Example 9, the 30th fall caused separation of the first and second PC plates.

TABLE 1

| | | | Second material | | | | | | | | | |
|---|---|---|---|---|---|---|---|---|---|---|---|---|
| | First material | | Monomer(s) | | | | | | | | | |
| | Polymer (a1) | | | | Number of | | | Stress | | | | |
| | | Molecular | | Molecular | functional | Number of | Composition | integral | | Elongation | | |
| | | weight | | weight | groups | parts used | index | value | | at break | | Wₘᵢₙ/ |
| | Species | D | Species | C | (A) | (B) | Y1 | (Mpa) | Hysteresis | X (%) | Necking | Wₘₐₓ |
| Ex. 1 | P1 | 1000000 | APG400 | 536 | 2 | 21 | 0.78 | 25 | 2.1 | 1300 | Present | 0.47 |
| Ex. 2 | P1 | 1000000 | APG700 | 796 | 2 | 22 | 0.55 | 21 | 2.8 | 1100 | Present | 0.51 |
| Ex. 3 | P2 | 1600000 | APG700 | 796 | 2 | 16 | 0.25 | 15 | 2.3 | 1400 | Present | 0.62 |
| Ex. 4 | P1 | 1000000 | APG700 | 796 | 2 | 15 | 0.56 | 14 | 2.7 | 1400 | Present | 0.58 |
| | | | MEA | 130 | 1 | 5 | | | | | | |
| | | | All monomers | 630 | 1.75 | 20 | | | | | | |
| Ex. 5 | P1 | 1000000 | CORONATE L | 672 | 3 | 10 | 0.45 | 20 | 1.7 | 800 | Present | 0.72 |
| Ex. 6 | P2 | 1600000 | CORONATE L | 672 | 3 | 10 | 0.28 | 24 | 1.6 | 750 | Present | 0.78 |
| Ex. 7 | P2 | 1600000 | CORONATE L | 672 | 3 | 8 | 0.22 | 11 | 1.6 | 900 | Present | 0.85 |
| Ex. 8 | P3 | 1000000 | CORONATE L | 672 | 3 | 10 | 0.45 | 66 | 1.7 | 650 | Present | 0.82 |
| Ex. 9 | P1 | 1000000 | APG400 | 536 | 2 | 5 | 0.19 | 9 | 1.2 | 2500 | Absent | 0.95 |
| Ex. 10 | P1 | 1000000 | APG400 | 536 | 2 | 30 | 1.12 | 7 | 4.1 | 100 | Absent | 0.97 |

TABLE 2

| | | | Second material | | | | | | | | | |
|---|---|---|---|---|---|---|---|---|---|---|---|---|
| | First material | | Monomer(s) | | | | | | | | | |
| | Polymer (a1) | | | | Number of | | | Stress | | | | |
| | | Molecular | | Molecular | functional | Number of | Composition | integral | | Elongation | | |
| | | weight | | weight | groups | parts used | index | value | | at break | | Wₘᵢₙ/ |
| | Species | D′ | Species | C | (A) | (B) | Y2 | (Mpa) | Hysteresis | X (%) | Necking | Wₘₐₓ |
| Ex. 11 | P4 | 28000 | CORONATE L | 672 | 3 | 4 | 6.38 | 455 | 9.5 | 2000 | Present | 0.52 |
| Ex. 12 | P4 | 28000 | CORONATE L | 672 | 3 | 3 | 4.78 | 10 | 1.4 | 500 | Absent | 0.94 |

As shown in Table 1, the resin films of Examples 1 to 8 all had high stress integral values, and were supple and durable. The resin films of Examples 1 to 8 all had large hysteresis values. This suggests that they have a double network structure in which a first network is physically interlaced with a second network harder than the first. In addition, as compared to the PSA layer (resin film) of Example 9 with a low stress integral value, the PSA layer (resin film) of Example 1 with a higher stress integral value showed clearly superb impact resistance. The resin sheet of Example 9 (composition value Y1=0.19) had a breaking stress of 1.8 MPa and a stress integration area ratio of 20%. On the other hand, the resin sheet of Example 3 (Y1=0.25) had a breaking stress of 2.6 MPa and a stress integration area ratio of 41%; the resin sheet of Example 6 (Y1=0.28) had a breaking stress of 5.5 MPa and a stress integration area ratio of 58%; and the resin sheet of Example 1 (Y1=0.78) had a breaking stress of 3.1 MPa and a stress integration area ratio of 62%. As for the resin sheet of Example 8 (substrate film), the breaking stress was 14.5 MPa and the stress integration area ratio was 70%.

With respect to Examples 11 and 12 using a polyester-based polymer as the polymer (a1) in the first material, Table 2 outlines the features and summarizes the test results. Similar to the Examples shown in Table 1, as compared with the resin film of Example 12 having a low stress integral value, the resin film of Example 11 also having a low stress integral value is more supple and durable. It is noted that the resin sheet of Example 11 had a breaking stress of 54.3 MPa and a stress integration area ratio of 42%.

Although specific embodiments of the present invention have been described in detail above, these are merely for illustrations and do not limit the scope of the claims. The art according to the claims includes various modifications and changes made to the specific embodiments illustrated above.

### REFERENCE SIGNS LIST

1, 2, 3 PSA sheets
10 PSA layer (adhesive resin film)
10A first surface (adhesive face)
10B second surface
20 substrate
20A first face
20B second face (backside)
30, 31, 32 release liners
50 release-linered PSA sheet
110 PSA layer
110A first surface (adhesive face)
110B second surface
120 substrate (non-adhesive or lightly-adhesive resin film)
120A first face
120B second face (backside)

1. A resin film that has a stress integral value of greater than 10 MPa and 1000 MPa or less when uniaxially stretched at a tensile speed of 300 mm/min at 25° C. until it breaks.

2. The resin film according to claim 1, that has an elongation at break of 300% or higher and 4500% or lower when uniaxially stretched at a tensile speed of 300 mm/min at 25° C. until it breaks.

3. The resin film according to claim 1, that has a hysteresis of 1.2 or higher and 20 or lower at 25° C., obtained by the following test:
[test method]
(I) samples A and B are obtained for breaking elongation measurement and hysteresis measurement, respectively;
(II) at 25° C., the sample A is uniaxially stretched at a tensile speed of 300 mm/min until it breaks to determine the elongation at break, X (%);
(III) at 25° C., the sample B is subjected to the first stretching cycle where it is uniaxially stretched at a tensile speed of 300 mm/min to 0.7X (%) from the initial chuck distance and held for 1 second at the end of the stretching; and then pulled back at a pulling-back speed of 300 mm/min to the initial chuck distance of 10 mm and held for 10 seconds; and subsequently, the sample B is subjected to the second stretching cycle where it is uniaxially stretched to 0.8X (%) from the initial chuck distance and held for 1 second at the end of the stretching; and then pulled back at a pulling-back speed of 300 mm/min to the initial chuck distance and held for 10 seconds; and
(IV) from the stress S1 (MPa) required to stretch the sample B to (0.7X−40) % elongation in the first stretching cycle and the stress S2 (MPa) required to stretch the sample B to (0.7X−40) % elongation, S1/S2 is determined and this value is used as the hysteresis.

4. The resin film according to claim 1, that shows necking behavior that results in a ratio (Wₘᵢₙ/Wₘₐₓ) of higher than 0 and 0.90 or lower at 25° C. based on the following necking test:
[necking test]
(I) samples A and C are obtained for breaking elongation measurement and necking measurement, respectively;
(II) at 25° C., the sample A is uniaxially stretched at a tensile speed of 300 mm/min until it breaks to determine the elongation at break, X (%);
(III) at 25° C., the sample C is uniaxially stretched at a tensile speed of 300 mm/min from the initial chuck distance to 0.5X (%); at the end of the stretching, within 1 second after the end of the stretching, a photograph of the stretched sample is taken with a digital camera, wherein the photograph is taken from a direction perpendicular to the stretching direction of the sample; and
(IV) with respect to the middle 60% range excluding 20% from each end of the stretched sample, the sample's minimum width Wₘᵢₙ and maximum width Wₘₐₓ are measured in number of pixels to determine their ratio (Wₘᵢₙ/Wₘₐₓ).

5. The resin film according to claim 1, wherein the resin film comprises first and second networks coexisting in the same layer, and the first and second networks are physically interlaced with each other through net holes.

6. The resin film according to claim 5, wherein the first network is a cured product of a first material, with the first material comprising a polymer (a1) having reactive functional groups (f1); and the second network is a cured product of a second material, with the second material comprising a polyfunctional monomer (b1) having two or more reactive functional groups (f2) in one molecule.

7. The resin film according to claim 6, wherein the polymer (a1) is an acrylic polymer.

8. The resin film according to claim 7, wherein the polymer (a1) has a weight average molecular weight of 80×10⁴ or higher.

9. The resin film according to claim 7, that has a composition index Y1 of 0.20 or higher and 0.85 or lower, determined as follows: based on the average number (A) of functional groups of all the monomers in the second material, the number (B) of parts (by weight) of all the monomers used per 100 parts by weight of the polymer (a1), the average molecular weight C of all the monomers, and the weight average molecular weight D of the polymer (a1), the composition index Y1 is determined by the following equation (1):
Y1=[(AB/C)/D]×10⁷ (1)

10. The resin film according to claim 6, wherein the polymer (a1) is a polyester-based polymer.

11. The resin film according to claim 10, that has a composition index Y2 of 6.0 or higher and 7.0 or lower, determined as follows: based on the average number (A) of functional groups of all the monomers in the second material, the number (B) of parts (by weight) of all the monomers used per 100 parts by weight of the polymer (a1), the weight average molecular weight C of all the monomers, and the number average molecular weight D′ of the polymer (a1), the composition index Y2 is determined by the following equation (2):
Y2=[(AB/C)/D′]×10⁷ (2)

12. A pressure-sensitive adhesive sheet comprising the resin film according to claim 1.

13. A resin composition, that is used for forming the resin film according to claim 1.
